(19) United States
(12) Patent Application Publication
(10) Pub. No.: US 2007/0096631 A1
(43) Pub. Date: May 3, 2007

(54) Flat panel display and fabricating method thereof

(76) Inventors: Un-cheol Sung, Anyang-si (KR); Hoon Kim, Hwaseong-si (KR); Won-hoe Koo, Suwon-si (KR); Jung-mi Choi, Yongin-si (KR); Sang-pil Lee, Seoul (KR)

Correspondence Address: CANTOR COLBURN, LLP, 55 GRIFFIN ROAD SOUTH, BLOOMFIELD, CT, 06002, US

(21) Appl. No.: 11/591,074

(22) Filed: Nov. 1, 2006

(30) Foreign Application Priority Data
Nov. 1, 2005 (KR) 2005-0103745
Apr. 11, 2006 (KR) 2006-0032881
Sep. 4, 2006 (KR) 2006-0084737

(51) Int. Cl. H01J 1/62; H01J 63/04

(52) U.S. Cl. 313/498

(57) ABSTRACT

A flat panel display includes an insulating substrate with a display element, a cover substrate facing and joined with the insulating substrate, and a frit formed along an edge between the insulating substrate and the cover substrate. Thus, the present invention provides a flat panel display that can minimize inflow of oxygen and moisture from the outside.

This application claims priority to Korean Patent Application No. 2005-0103745, filed on Nov. 1, 2005, No. 2006-0032881, filed on Apr. 11, 2006, and No. 2006-0084737, filed on Sep. 4, 2006 and all the benefits accruing therefrom under 35 U.S.C. §119, and the contents of which in their entireties are herein incorporated by reference.

### BACKGROUND OF THE INVENTION

1. Field of the Invention

The present invention relates to a flat panel display and a fabricating method thereof, and more particularly, to a flat panel display that can minimize inflow of oxygen and moisture from the outside and a fabricating method thereof.

2. Description of the Related Art

Among flat panel displays, an organic light emitting diode (“OLED”) has some advantages because it is driven with a low voltage, is thin and light, has a wide view angle, has a relatively short response time, etc. The OLED includes a thin film transistor (“TFT”) having a gate electrode, a source electrode and a drain electrode. The OLED also includes a pixel electrode connected to the TFT, a partition wall dividing the pixel electrodes from each other, an organic emission layer formed on the pixel electrode between the partition walls, and a common electrode formed on the organic emission layer.

Here, the organic emission layer is susceptible to moisture and oxygen. Therefore, the performance and the lifespan of the organic emission layer are likely to be decreased by moisture and oxygen. To prevent the organic emission layer from deteriorating, an encapsulating process is performed to make an insulating substrate provided with the organic emission layer face and combined to a cover substrate for blocking moisture and oxygen. Further, an organic sealant is formed along an edge between the two substrates, thereby joining the two substrates together.

However, the organic sealant has a relatively high permeability to moisture (i.e., about 10 g/m² day). Therefore, a water getter has been internally provided in the flat panel display so as to remove permeated moisture. In this conventional method, the water getter increases a production cost, and the permeated moisture is likely to deteriorate the organic emission layer, thereby decreasing the lifespan and the performance of the flat panel display.

### BRIEF SUMMARY OF THE INVENTION

Accordingly, the present invention provides a flat panel display that can minimize inflow of oxygen and moisture from the outside.

Another aspect of the present invention provides a method of fabricating a flat panel display that can minimize inflow of oxygen and moisture from the outside.

Additional aspects and/or advantages of the present invention will be set forth in part in the description which follows and, in part, will be obvious from the description, or may be learned by practice of the present invention.

The foregoing and/or other aspects of the present invention can be achieved by providing a flat panel display including an insulating substrate having a display element disposed thereon, a cover substrate facing and joined with the insulating substrate, and a frit formed along an edge between the insulating substrate and the cover substrate.

According to another aspect of the present invention, the flat panel display may further include a heat transfer member formed along the frit, and the heat transfer member may be inserted in the frit. Alternatively, the heat transfer member may be provided between the frit and at least one of the insulating substrate and the cover substrate. In yet another alternative embodiment, the heat transfer member is provided in at least one side of the frit.

The heat transfer member may include at least one wiring line. The heat transfer member may be arranged in a zigzag shape or arranged like a mesh. Alternatively, the heat transfer member may be shaped like a sheet having a predetermined width, such as shaped like a thin film.

The frit may have a width within a range of 0.1 mm to 5 mm, and a thickness within a range of 5 μm to 3 mm.

The frit may be cured by heat.

The heat transfer member may have a thickness within a range of 50 μm to 5 mm, and a width within a range of 5 μm to 5 mm.

Alternatively, the heat transfer member may have a thickness within a range of 5 μm to 50 μm, and a width within a range of 0.1 mm to 5 mm.

The heat transfer member may include at least one of nickel, tungsten, Kanthal and alloy thereof. The frit and the heat transfer member may be alternately stacked to have a multi-layered structure. The heat transfer member may be formed with a passivation layer for anti-oxidization, where the passivation layer may include an inorganic layer including at least one of an oxide layer, a nitride layer, and pyro-carbon.

The insulating substrate may be provided with a signal line, and at least one of the frit and the heat transfer member may at least partially overlap with the signal line, and a width of the heat transfer member in an overlapped region may be different from that of a non-overlapped region. The width of the heat transfer member in the overlapped region may be narrower than that of the non-overlapped region.

According to another aspect of the present invention, the flat panel display may further include a filler that is interposed between the insulating substrate and the cover substrate and joins the two substrates together, and the filler may include a first part spaced apart from the frit and covering the display element, and a second part interposed between the frit and the insulating substrate.

In such an embodiment, the frit may have a thickness within a range of 100 μm to 600 μm, and the frit may have a permeability to moisture within a range of 1 g/m² day to 10 g/m² day.

The flat panel display may further include a moisture absorber provided in a space between the frit and the first part. The moisture absorber may be spaced apart from at least one of the frit and the first part at a predetermined distance, and may include at least one of calcium Ca and barium Ba.

The flat panel display may further include a first inorganic film interposed between the display element and the filler, and may further include a second inorganic film and an additional filler, which are interposed between the filler and the insulating substrate, wherein the second inorganic film is placed on the first filler, and the additional filler is placed between the second inorganic film and the cover substrate.

The first and second inorganic films may have a thickness of 100 nm through 3000 nm, and may have a multi-layered structure.

A surface of the frit facing the insulating substrate may be planarized.

The foregoing and/or other aspects of the present invention may also be achieved by providing a method of fabricating a flat panel display, the method including preparing a cover substrate, forming a first frit along an edge of the cover substrate, forming a heat transfer member along the first frit, forming a second frit on the heat transfer member, and aligning an insulating substrate with the cover substrate, the insulating substrate having a display element, and curing the first and second frits by supplying power to the heat transfer member.

The method may further include semi-curing the first frit before forming the heat transfer member. Semi-curing the first frit may be performed at a temperature of 100° C. through 250° C., and may use at least one of an oven, a hot-plate, and a laser.

Alternatively, the method may further include semi-curing the first frit after forming the heat transfer member, wherein semi-curing the first frit may be performed by supplying power to the heat transfer member. In such an embodiment, the method may further include planarizing the first frit between semi-curing the first frit and aligning the insulating substrate with the cover substrate.

The first and second frits may be formed by either of a dispensing method or a screen-printing method. The curing process may be performed at a temperature of 300° C. or more. The heat transfer member may be formed by at least one of a sputtering method and a chemical vapor deposition. The aligning process for the cover and insulating substrates and the curing process for the first and second frits may be performed in a vacuum chamber. The heat transfer member may receive high frequency power from an RF power source in the curing process.

The method may further include forming a passivation layer for anti-oxidization on the heat transfer member.

The foregoing and/or other aspects of the present invention may further be achieved by providing a method of fabricating a flat panel display, the method including preparing a cover substrate, forming a frit along an edge of the cover substrate, curing the frit, forming a filler on at least one of the cover substrate and an insulating substrate formed with a display element, and curing a filler after joining the cover substrate and the insulating substrate together.

The method may further include planarizing one surface of the frit facing the insulating substrate after curing the frit.

The filler may include a first part corresponding to the display element on either of the insulating substrate or the cover substrate, and a second part formed on one surface of the frit.

The method may further include interposing a moisture absorber within a space between the frit and the first part either before or after forming the filler.

The method may further include forming a first inorganic film covering at least a part of the display element either before or after forming the filler.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a perspective view illustrating a structure of an exemplary flat panel display according to a first exemplary embodiment of the present invention;

FIG. 2 is a sectional view of the exemplary flat panel display, taken along line II-II in FIG. 1;

FIG. 3 is an enlarged perspective view of portion ‘A’ in FIG. 1;

FIG. 4 is a perspective view illustrating a structure of an exemplary flat panel display according to a second exemplary embodiment of the present invention;

FIG. 5 is a perspective view illustrating a structure of an exemplary flat panel display according to a third exemplary embodiment of the present invention;

FIG. 6 is a perspective view illustrating a structure of an exemplary flat panel display according to a fourth exemplary embodiment of the present invention;

FIG. 7 a perspective view illustrating a structure of an exemplary flat panel display according to a fifth exemplary embodiment of the present invention;

FIG. 8 is a sectional view of an exemplary flat panel display according to a sixth exemplary embodiment of the present invention;

FIG. 9 is a plan view of an exemplary flat panel display according to a seventh exemplary embodiment of the present invention;

FIG. 10A is a perspective view illustrating a structure of an exemplary flat panel display according to an eighth exemplary embodiment of the present invention, and FIG. 10B is an enlarged perspective view of portion B of FIG. 10A;

FIG. 11 is a sectional view of the exemplary flat panel display, taken along line XI-XI in FIG. 10;

FIG. 12 is a sectional view illustrating a structure of an exemplary flat panel display according to a ninth exemplary embodiment of the present invention;

FIG. 13 is a sectional view illustrating a structure of an exemplary flat panel display according to a tenth exemplary embodiment of the present invention;

FIG. 14 is a sectional view illustrating a structure of an exemplary flat panel display according to an eleventh exemplary embodiment of the present invention;

FIG. 15 is a perspective view illustrating a structure of an exemplary flat panel display according to a twelfth exemplary embodiment of the present invention;

FIG. 16 is a sectional view of the exemplary flat panel display, taken along line XVI-XVI in FIG. 15;

FIG. 17 is an enlarged perspective view of portion ‘D’ in FIG. 15;

FIG. 18A is an exploded perspective view of an exemplary flat panel display according to the twelfth exemplary embodiment of the present invention, and FIG. 18B is an enlarged perspective view of portion E in FIG. 18A;

FIGS. 19A through 19E illustrate an exemplary method of fabricating the exemplary flat panel display according to the first exemplary embodiment of present invention;

FIGS. 20A through 20G illustrate an exemplary method of fabricating the exemplary flat panel display according to the eighth exemplary embodiment of the present invention;

FIGS. 21A through 21F illustrate an exemplary method of fabricating the exemplary flat panel display according to the twelfth exemplary embodiment of the present invention; and

FIGS. 22A through 22C illustrate another exemplary method of fabricating the exemplary flat panel display according to the twelfth exemplary embodiment of the exemplary flat panel display.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, embodiments of the present invention will be described in more detail with reference to accompanying drawings. For example, an organic light emitting diode (“OLED”) among various flat panel displays will be described below, but the present invention is not limited thereto. Alternatively, the present invention may be applied to another flat panel display such as a liquid crystal display (“LCD”), a plasma display panel (“PDP”), etc. In the following embodiments, a frit is employed as one of various sealants, but the present invention is not limited thereto. Alternatively, any sealant can be used as long as it is cured by heat and has a low permeability to moisture or oxygen.

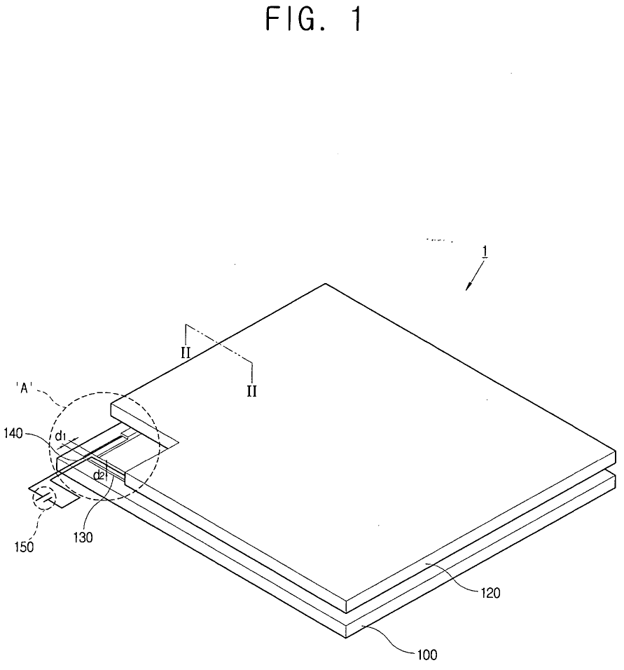

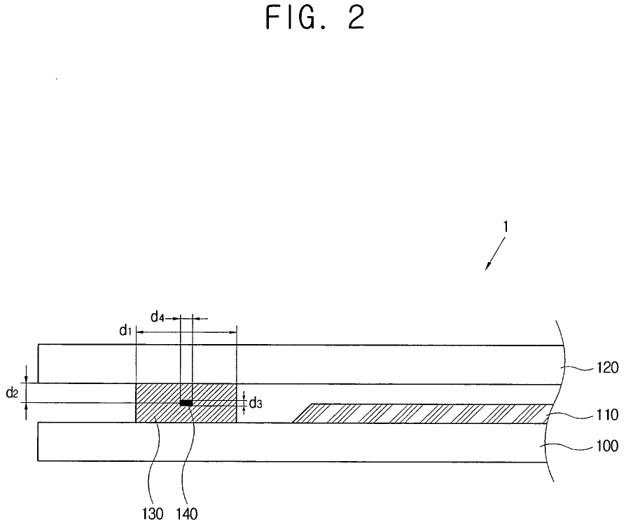

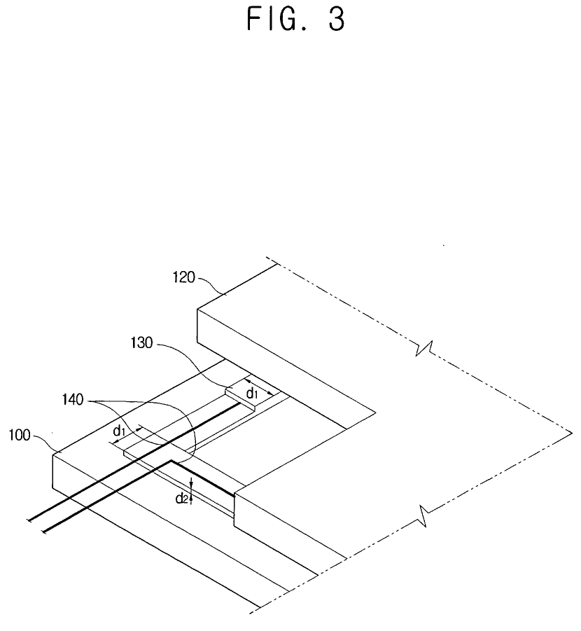

FIG. 1 is a perspective view illustrating a structure of an exemplary flat panel display according to a first exemplary embodiment of the present invention, FIG. 2 is a sectional view of the exemplary flat panel display, taken along line II-II in FIG. 1, and FIG. 3 is an enlarged perspective view of portion ‘A’ in FIG. 1.

An OLED 1 includes an organic material that receives an electric signal and emits light by itself. Such an organic material is susceptible to moisture, such as water, and oxygen. Therefore, an encapsulating method can be employed to effectively prevent oxygen and moisture from being permeated into the organic material (an organic emission layer).

As shown in FIGS. 1 through 3, an OLED 1 according to a first exemplary embodiment of the present invention includes an insulating substrate 100 provided with a display element 110 to display an image, a cover substrate 120 facing and combining with the insulating substrate 100 and preventing oxygen or moisture from being introduced into the display element 110, a frit 130 formed along an edge between the insulating substrate 100 and the cover substrate 120, and a heat transfer member 140 formed along the frit 130.

The insulating substrate 100 is transparent, and may include a glass substrate or a plastic substrate. Further, a barrier layer (not shown) may be formed on the insulating substrate 100, i.e., between the display element 110 and the insulating substrate 100. The barrier layer prevents oxygen or moisture from being introduced into the display element 110 through the insulating substrate 100, and may include SiON, SiO₂, SiNₓ, Al₂O₃, etc. Here, the barrier layer can be formed by a sputtering method.

The display element 110 can be provided by a well-known method. Further, the display element 110 includes a thin film transistor (“TFT”) having a gate electrode, a source electrode, and a drain electrode. The display element 110 further includes a pixel electrode connected to the TFT, a partition wall dividing the pixel electrodes from each other, an organic emission layer formed on the pixel electrode between the partition walls, and a common electrode formed on the organic emission layer. Here, the display element 110 displays an image corresponding to a video signal outputted from an information processor. Although a particular embodiment of the display element 110 is described, other features of the display element 110 may also be incorporated.

The cover substrate 120 may be made of the same material as the insulating substrate 100. For example, the cover substrate 120 may include a soda-lime glass substrate, a boro-silicate glass substrate, a silicate glass substrate, a lead glass substrate, or etc. Here, the cover substrate 120 can have a thickness of 0.1 mm through 10 mm, and more preferably may have a thickness of 1 mm through 10 mm, thereby preventing moisture and oxygen from being permeated into the display element 110 through the cover substrate 120.

The frit 130 is formed along the edge between the insulating substrate 100 and the cover substrate 120. The frit 130 may be formed on a non-display region of the OLED 1. Here, the frit 130 is employed as a sealant for preventing oxygen or moisture from being introduced through a gap between the insulating substrate 100 and the cover substrate 120. In this embodiment, the frit 130 is described as one among various sealants, but not limited thereto. Alternatively, any sealant can be employed as long as it is cured by heat and has a very low permeability to moisture or oxygen. In addition, the frit 130 is used for joining the two substrates 100 and 120 together.

The frit 130 has a width d1 of 0.1 mm through 5 mm, and a thickness d2 of 5 μm through 3 mm. If the width d1 of the frit 130 is smaller than 0.1 mm, then a joining strength between the two substrates 100 and 120 would be deteriorated and defective. It would also be difficult to apply a dispensing method or a screen-printing method to form the frit 130 if the width d1 of the frit 130 is smaller than 0.1 mm. On the other hand, if the width d1 of the frit 130 is larger than 5 mm, then the area of the frit 130 would be too large to be entirely cured by the heat transfer member 140. In such a case, the flat panel display would not be sufficiently protected from heat and moisture. Meanwhile, if the thickness d2 of the frit 130 is smaller than 5 μm, then it would be difficult to apply the dispensing method or the screen-printing method to form the frit 130, and the defective joining may arise. On the other hand, if the thickness d2 of the frit 130 is larger than 3 mm, then the frit 130 would not be entirely cured by the heat transfer member 140, and it would further be difficult to make the flat panel display thin. For example, the frit 130 has a width d1 of 1 mm through 2 mm, and a thickness d2 of 100 μm through 600 μm. Here, the width d1 and the thickness d2 of the frit 130 can increase or decrease in proportion to the size of the flat panel display.

The frit 130 may include an adhesive powdered glass such as SiO₂, TiO₂, PbO, PbTiO₃, Al₂O₃, etc. Such a frit 130 has a very low permeability to moisture and oxygen, so that the organic emission layer in the display element 110 is prevented from deteriorating and a water getter is not required. Further, the frit 130 has a sufficient durability to endure vacuum mounting, so that the OLED 1 can be fabricated in a vacuum chamber, thereby minimizing the permeability of oxygen and moisture from the outside. Thus, the lifespan of the flat panel display increases and the performance thereof is improved. Here, the frit 130 is thermosetting, but the present invention is not limited thereto. Alternatively, the frit 130 may be thermoplastic.

The frit 130 may be cured at a high temperature. Therefore, a laser may be locally applied to the frit 130, thereby curing the frit 130. However, in a method using the laser, high technology is required for laser-scanning, bubbles arise in the frit 130, adhesion between heterogeneous substrates is difficult due to difference in a thermal expansion coefficient, and the laser is likely to cause a metal wiring line such as gate and data lines to have defects. In the meantime, an organic sealant to be cured by light or heat can be used together with the frit 130. When both the organic sealant and the frit 130 are used, it is possible to get good results as compared with the case of using only the sealant. However, in this case, a processing cost due to using the frit 130 is relatively high and the above-mentioned problem due to using the laser may still arise.

To avoid the above-described issues, according to exemplary embodiments of the present invention, a member for locally applying heat to the frit 130 is provided along the frit 130, and power is supplied to this member, thereby making it generate heat. For example, as shown in FIGS. 1 through 3, the heat transfer member 140 is formed along the frit 130, and power is supplied to the heat transfer member 140, thereby curing the frit 130. Referring to FIGS. 1 through 3, the heat transfer member 140 is inserted inside the frit 130. The heat transfer member 140 may include a plurality of wiring lines such as hot wires, which are arranged in parallel with each other, but not shown. Further, the heat transfer member 140 has opposite ends connected to a power supply 150, as will be further described below. When the power supply 150 supplies power to the heat transfer member 140, the heat transfer member 140 generates heat to cure the frit 130. That is, when power is supplied to the heat transfer member 140, the internal resistance of the heat transfer member 140 causes heat, so that the frit 130 is cured. Here, the heat transfer member 140 includes at least one of nickel, tungsten, kanthal and alloy thereof, and is formed by a sputtering method or a chemical vapor deposition (“CVD”) method. Further, the heat transfer member 140 may be covered with a passivation layer to prevent the heat transfer member 140 from being oxidized. Here, the passivation layer may be an inorganic material including at least one of an oxide layer, a nitride layer, and pyro-carbon. Also, the heat transfer member 140 is conductive. Meanwhile, the frit 130 and the heat transfer member 140 may be alternately stacked to have a multi-layered structure. In other words, the heat transfer member 140 may be formed in more than one layer with the frit 130 formed between layers of the heat transfer member 140.

The heat transfer member 140 may have a thickness d3 of 50 μm through 5 mm. If the thickness d3 of the heat transfer member 140 is smaller than 50 μm, then it would be unsuitable to generate sufficient heat for curing the frit 130. In more detail, a temperature of 300° C. or more is required to cure the frit 130. From an electrical resistance point of view, if the thickness d3 of the heat transfer member 140 is smaller than 50 μm, then the heat transfer member 140 would likely be short-circuited by high voltage applied thereto, so that it would be difficult to make a temperature of 300° C. or more. Further, if the thickness d3 is relatively small, then it would be difficult to locally cure the frit 130, thereby causing defective adhesion. On the other hand, if the thickness d3 of the heat transfer member 140 is larger than 5 mm, then it would be difficult to make the flat panel display thin and the internal metal wiring line of the display element 110 may be deteriorated by excessively high temperature heat. For instance, the gate line or the data line within the display element 110 may include aluminum that has a relatively low melting point, so that the resistance thereof may be varied by high temperature. If the metal wiring line of the display element 110 is deteriorated, then a video signal would be abnormally transmitted through the metal wiring line, and a desired image would not be displayed.

Further, the heat transfer member 140 can have a width d4 of 5 μm through 5 mm. If the width d4 is smaller than 5 μm, then the heat transfer member 140 may be short-circuited from the electrical resistance point of view, it would be difficult to make a temperature of 300° C. or more, and it would be difficult to locally cure the frit 130, thereby causing defective adhesion. On the other hand, if the width d4 is larger than 5 mm, it would be difficult to make the flat panel display thin and the internal metal wiring line of the display element 110 may be deteriorated by excessively high temperature heat.

To cure the frit 130 more effectively, it is preferable that the thickness d3 and the width d4 of the heat transfer member 140 are formed in proportion to the width d1 and the thickness d2 of the frit 130.

Both ends of the heat transfer member 140 are connected to the power supply 150. The power supply 150 is not included in the OLED 1, and is disconnected from the OLED 1 after supplying power to the heat transfer member 140 for curing the frit 130. In general, the power supply 150 may be implemented by a well-known device. Further, a radio frequency (“RF”) power source of supplying high frequency power may be used as the power supply 150.

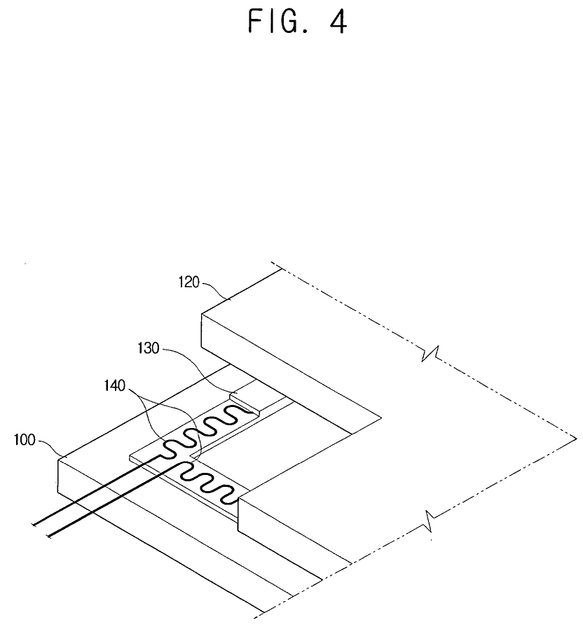

Below, flat panel displays according to the second through sixth exemplary embodiments of the present invention will be described with reference to FIGS. 4 though 8, in which the second through sixth embodiments show various shapes of the heat transfer member 140. Only different points as compared with the first embodiment will be described. Therefore, like elements refer to like numerals, and repetitive descriptions will be avoided as necessary.

FIG. 4 is a perspective view illustrating a structure of an exemplary flat panel display according to a second exemplary embodiment of the present invention. As shown therein, the heat transfer member 140 is arranged in a zigzag or serpentine shape. Here, the width and the thickness of the frit 130 and the heat transfer member 140 may be the same as those of the first exemplary embodiment. As the heat transfer member 140 is formed in a zigzag shape, heat is uniformly applied to the frit 130, thereby entirely curing the frit 130. Therefore, the defective adhesion between two substrates 100 and 120 is minimized. Further, there is provided a flat panel display that can minimize inflow of oxygen and moisture from the outside.

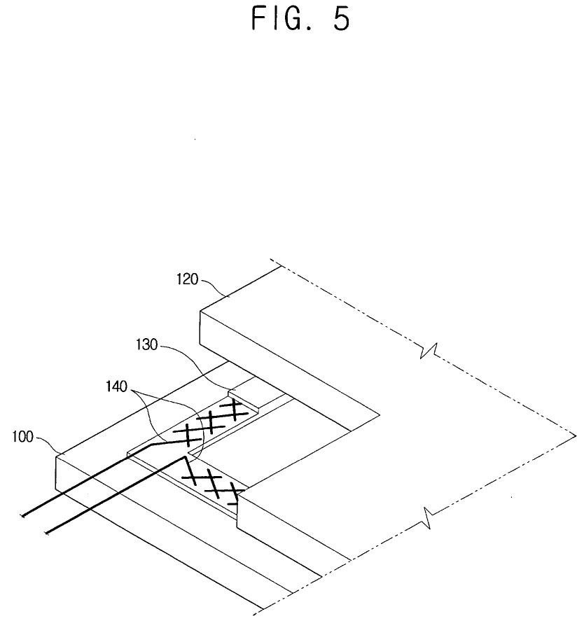

FIG. 5 is a perspective view illustrating a structure of an exemplary flat panel display according to a third exemplary embodiment of the present invention. As shown therein, the heat transfer member 140 is shaped like a mesh with portions of the mesh-like shape intersecting with each other. Here, the width and the thickness of the frit 130 and the heat transfer member 140 may be substantially the same as those of the first exemplary embodiment. As the heat transfer member 140 is formed in a mesh pattern on the frit 130, heat is uniformly applied to the frit 130, thereby entirely curing the frit 130. Therefore, the defective adhesion between two substrates 100 and 120 is minimized. Further, there is provided a flat panel display that can minimize inflow of oxygen and moisture from the outside.

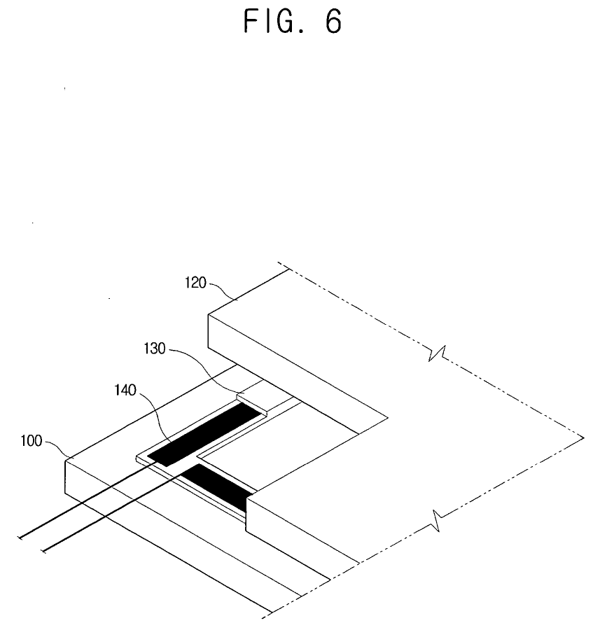

FIG. 6 is a perspective view illustrating a structure of an exemplary flat panel display according to a fourth exemplary embodiment of the present invention. As shown therein, the heat transfer member 140 is shaped like a sheet having a predetermined width. Here, the width of the heat transfer member 140 may be smaller than or equal to that of the frit 130, but the thickness of the frit 130 and the heat transfer member 140 may be substantially the same as those according to the first exemplary embodiment. As the heat transfer member 140 is formed to have a sheet shape on the frit 130, heat is uniformly applied to the frit 130, thereby entirely curing the frit 130. Therefore, the defective adhesion between two substrates 100 and 120 is minimized. Further, there is provided a flat panel display that can minimize inflow of oxygen and moisture from the outside.

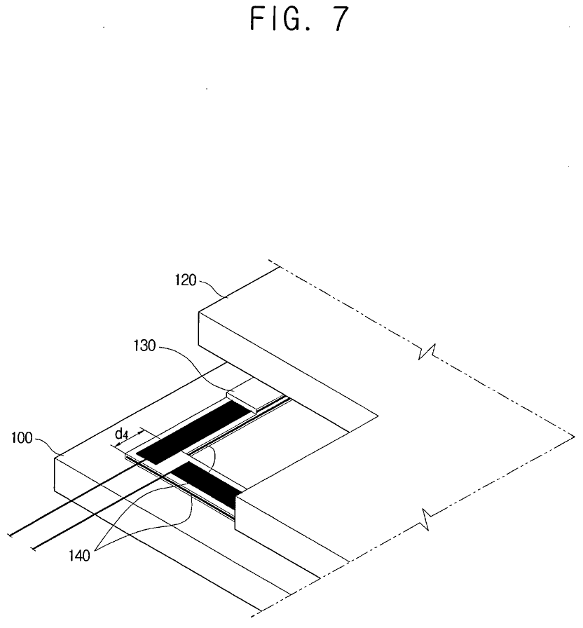

FIG. 7 a perspective view illustrating a structure of an exemplary flat panel display according to a fifth exemplary embodiment of the present invention. As shown therein, the heat transfer member 140 is shaped like a thin film, and may be formed in multiple layers within the frit 130. For example, the heat transfer member 140 can have a thickness of 5 μm through 50 μm. If the thickness of the heat transfer member 140 is smaller than 5 μm, then it would be difficult to not only form the heat transfer member 140 but also make a temperature of 300° C. or more from the electrical resistance point of view. On the other hand, if the thickness of the heat transfer member 140 is larger than 50 m, then it would not be a thin film. In consideration of the electrical resistance point, the width d4 of the thin film heat transfer member 140 should be larger than that of the first exemplary embodiment, e.g., 0.1 mm through 5 mm. As shown in FIG. 7, the thin film heat transfer member 140 can be formed in at least one of the opposite lateral surfaces and the inside of the frit 130. Here, the heat transfer member 140 can be formed by the sputtering method or the chemical vapor deposition (“CVD”) method. As the heat transfer member 140 is shaped like a thin film, heat is uniformly applied to the frit 130, thereby entirely curing the frit 130. Further, there is provided a flat panel display that can minimize inflow of oxygen and moisture from the outside.

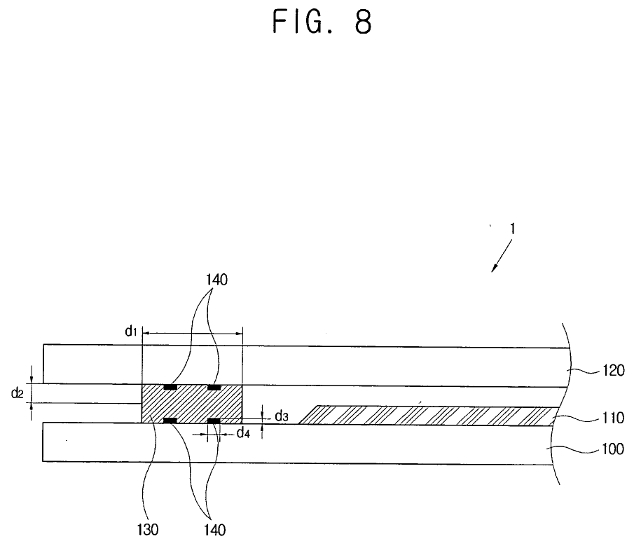

FIG. 8 is a sectional view of an exemplary flat panel display according to a sixth exemplary embodiment of the present invention. As shown in FIG. 8, the heat transfer member 140 is interposed between the insulating substrate 100 and the frit 130 and between the cover substrate 120 and the frit 130. That is, the heat transfer member 140 is first formed along the edges of the two substrates 110 and 120 to be formed with the frit 130, and then the frit 130 is formed between and around the heat transfer members 140. Here, the widths d1, d4 and the thicknesses d2, d3 of the frit 130 and the heat transfer member 140 may be substantially the same as those of the first exemplary embodiment. Thus, heat is uniformly applied to the frit 130, thereby entirely curing the frit 130. Further, there is provided a flat panel display that can minimize inflow of oxygen and moisture from the outside. Alternatively, the heat transfer member 140 may be either provided only between the insulating substrate 100 and the frit 130 or only between the cover substrate 120 and the frit 130.

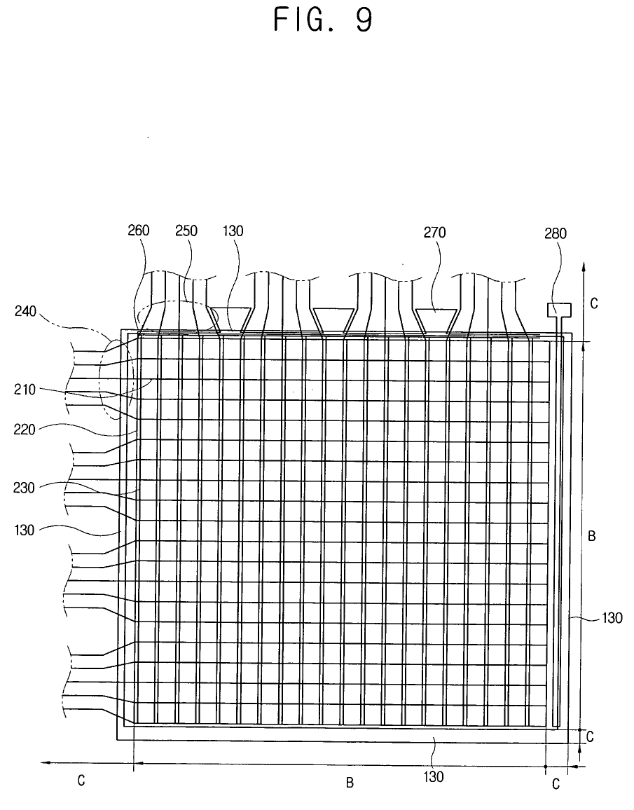

A flat panel display according to a seventh exemplary embodiment of the present invention will be described with reference to FIG. 9. In the seventh exemplary embodiment, the frit 130 and the heat transfer member 140 are applied to an exemplary OLED that is exemplarily illustrated as the flat panel display. FIG. 9 is a schematic plan view of the exemplary OLED as one type of flat panel display.

Referring to FIG. 9, a display region B of the flat panel display includes a plurality of gate lines 210 extended in a horizontal direction, a first direction, a plurality of data lines 220 extending in a vertical direction, a second direction substantially perpendicular to the first direction, and intersecting the gate lines 210 and defining pixels, a plurality of driving voltage lines 230 arranged in parallel with the data lines 220, a plurality of pixel TFTs formed in regions where the gate lines 210 intersect the data lines 220, and a plurality of driving TFTs formed in regions where the gate lines 210 intersect the driving voltage lines 230. Here, the gate line 210, the data lines 220, a common voltage bar 280, and fan-out portions 240 and 250 are used as signal lines for transmitting signals.

Further, in at least one side of a non-display region C of the flat display, there are provided a gate driving circuit connected to ends of the gate lines 210, and a data driving circuit connected to ends of the data lines 220. Here, the gate driving circuit and the data driving circuit supply various driving signals from the outside to the gate lines 210 and the data lines 220, respectively. As a connection type between the gate driving circuit and the data driving circuit, there may be a chip on glass (“COG”) in which a driver is directly mounted on a substrate, a tape carrier package (“TCP”) in which a driving circuit is attached to and mounted on a polymer film, a chip on film (“COF”) in which a driver is mounted on and then attached to a driving circuit substrate, etc. In the display region B, the gate lines 210 and the data lines 220 are extended toward the outside and connected to the gate driving circuit and the data driving circuit through a gate pad (not shown) and a data pad (not shown), respectively. Meanwhile, at least one gate fan-out portion 240 and at least one data fan-out portion 250 are formed in connection regions between the gate lines 210 and the gate driving circuit and between the data lines 220 and the data driving circuit, respectively. In the gate and data fan-out portions 240, 250, the gate lines 210 and the data lines 220 have narrower intervals there between, respectively.

The non-display region C includes the driving voltage bar 260 connected to one end of each of the driving voltage lines 230, and at least one driving voltage pad 270 applying a driving voltage to the driving voltage bar 260. The driving voltage lines 230 receive power from the outside through the driving voltage bar 260 and the driving voltage pad 270, and the power is supplied to the driving TFTs. The driving TFTs apply a predetermined voltage to the pixel electrodes, thereby allowing holes and electrons to be transitioned in the organic emission layers. Further, each pixel electrode includes the organic emission layer to emit light corresponding to the voltage applied from the pixel electrode. The common voltage bar 280 is provided in a side opposite to the gate fan-out portion 240 of the gate lines 210, but is not limited thereto. Alternatively, the common voltage bar 280 may be provided in a side opposite to fan-out portion 250 of the data lines 220. Further, the common voltage bar 280 may be provided in at least one of the gate fan-out portion 240 and the data fan-out portion 250. Here, the common voltage bar 280 is electrically connected to a common electrode to be entirely applied to the display region B, thereby applying a common voltage to the common electrode.

According to the seventh exemplary embodiment of the present invention, the frit 130 may be at least partially overlapped with either of the driving voltage bar 260 or the driving voltage pad 270. Further, the frit 130 may be at least partially overlapped with the common voltage bar 280. Also, the frit 130 may be at least partially overlapped with one of the gate fan-out portion 240 and the data fan-out portion 250.

That is, the insulating substrate 100 is provided with the common electrode, and the common voltage bar 280 for applying voltage to the common electrode. The frit 130 has a region overlapped with the common voltage bar 280, and the region may have a width different from the width of a region not overlapped with the common voltage bar 280 so as to minimize interaction (electric interference) with a common voltage. For example, the frit 130, which includes metal grains, or the metal heat transfer member 140, is narrowed in the region overlapped with the common voltage bar 280, thereby advantageously decreasing interaction (or electric interference). Further, on the insulating substrate 100 are formed the plurality of gate lines 210 and the gate fan-out portion or portions 240 in which the interval between the plurality of gate lines 210 narrows. The heat transfer member 140 and the frit 130 can have a width different from the region not overlapped with the gate fan-out portion or portions 240. For example, the frit 130, which includes metal grains, or the metal heat transfer member 140, is narrowed in the region overlapped with the gate fan-out portion or portions 240, thereby advantageously decreasing interaction (or electric interference).

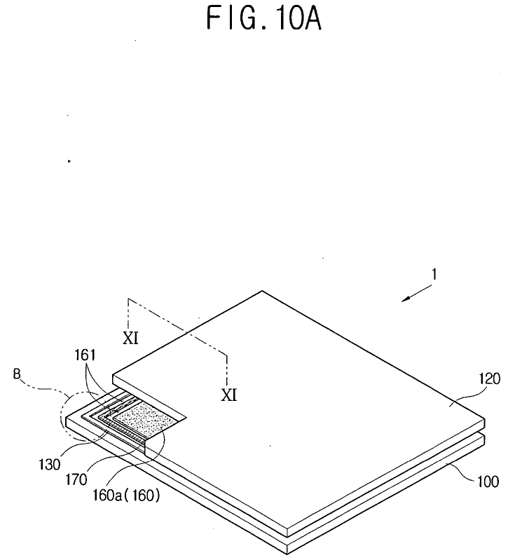

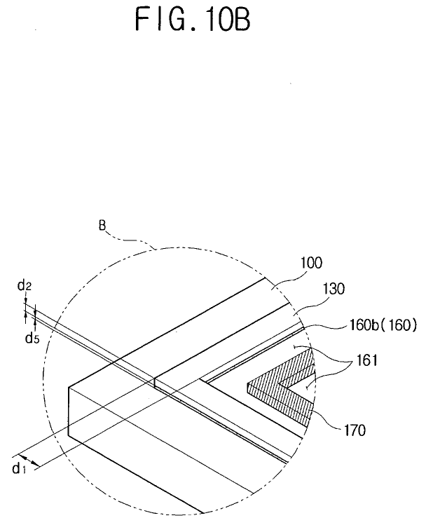

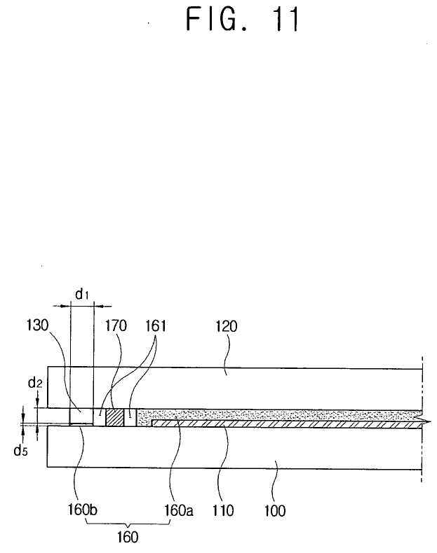

An exemplary flat panel display according to an eighth exemplary embodiment of the present invention will be described with reference to FIGS. 10A, 10B, and 11. The eighth exemplary embodiment relates to a sealing structure of the OLED, which is different from that of the first exemplary embodiment, and more particularly, to a sealing structure using a frit for sealing the OLED. In the eighth exemplary embodiment, only different features from the first exemplary embodiment will be described, and reference may be made to the first exemplary embodiment or to a known structure for omitted descriptions. For convenience, like numerals refer to like elements.

FIG. 10A is a perspective view illustrating a structure of an exemplary flat panel display according to an eighth exemplary embodiment of the present invention, FIG. 10B is an enlarged perspective view of portion B in FIG. 10A, and FIG. 11 is a sectional view of the exemplary flat panel display, taken along line XI-XI in FIG. 10A.

A frit 130 according to the eighth exemplary embodiment of the present invention is placed in an outer region of a display element 110, in which no image is displayed. The frit 130 has a width d1 of 0.1 mm through 5 mm, and a thickness d2 of 5 μm through 3 mm. If the width d1 of the frit 130 is smaller than 0.1 mm, then it would be difficult to apply a dispensing method, a screen-printing method, a slit-coating method, or a roll-coating method to form the frit 130. On the other hand, if the width d1 of the frit 130 is larger than 5 mm, then the margin of the outer region becomes larger, and there is no effect to overcome the shortcomings. Meanwhile, if the thickness d2 of the frit 130 is smaller than 5 μm, then it would be difficult to apply the dispensing method, the screen-printing method, the slit-coating method or the roll-coating method to form the frit 130. On the other hand, if the thickness d2 of the frit 130 is larger than 3 mm, then it would not be appropriate to make the flat panel display thin. For example, the frit 130 has a width d1 of 1 mm through 2 mm, and a thickness d2 of 100 μm through 600 μm, but the exemplary embodiments of the frit 130 are not limited thereto. Alternatively, the width d1 and the thickness d2 of the frit 130 can increase and decrease in proportion to the size of the flat panel display.

One surface of the frit 130 facing the insulating substrate 100 may be planarized by a polishing process. Thus, a top surface of the frit 130 is improved in flatness and uniformity, thereby enhancing adhesive uniformity and adhesive effect between the two substrates 100 and 120.

Further, the frit 130 has very low permeability to moisture and oxygen, for example, about 1 g/m² day through 10 g/m² day, so that it can prevent the organic emission layer within the display element 110 from deteriorating. Also, the frit 130 is formed on the cover substrate 120 and then cured to be joined with the insulating substrate 100, so that defects due to high temperature for curing the frit 130 can decrease. Here, the frit 130 can be cured by a laser or by a hot-wire or an oven in contact therewith. Preferably, the frit 130 may be thermoplastic.

A filler 160 is provided between the insulating substrate 100 and the cover substrate 120. The filler 160 may be a general sealant used for sealing the OLED 1. The filler 160 joins the two substrates 100 and 120 with each other, and serves to protect the organic emission layer within the display element 110 from moisture and oxygen. Here, the filler 160 includes an adhesive organic material and covers the display element 110. According to the eighth exemplary embodiment of the present invention, the filler 160 comprises a first part 160a covering the display element 110, and a second part 160b spaced apart from the first part 160a and formed on the frit 130. The first part 160a protects the display element 110, and the second part 160b joins the frit 130 with the insulating substrate 100. With this structure, the second part 160b can have a thickness d5 of about 5 μm or less, thereby minimizing moisture or oxygen that could be introduced through the second part 160b. Further, a space 161 is defined between the first part 160a and the second part 160b, and the space 161 is placed in a non-display region of the OLED.

The filler 160 can be formed by one of a dispenser method, the screen-printing method, the slit-coating method, and the roll-printing method. The width of the space 161 is sized sufficiently to form a moisture absorber 170 therein. For example, the moisture absorber 170 includes melamine resin, urea resin, phenol resin, resorcinol resin, epoxy resin, unsaturated polyester resin, poly urethane resin, acrylic resin, etc., but is not limited thereto.

The moisture absorber 170 is provided inside the space 161, and contacts both the insulating substrate 100 and the cover substrate 120. Here, the moisture absorber 170 prevents oxygen or moisture from being introduced through a gap formed between the insulating substrate 100 and the cover substrate 120. To enhance the performance of the moisture absorber 170, the moisture absorber 170 is preferably spaced apart from at least one of the first part 160a and the frit 130 by a predetermined distance. Thus, a space required for activating the moisture absorber 170 is secured. The moisture absorber 170 is a liquid thermoplastic material cured by heat, and has very low permeability to moisture and oxygen such that the organic emission layer within the display element 110 is prevented from deteriorating. Therefore, the lifespan and the performance of the flat panel display are improved. The moisture absorber 170 can be formed within the space 161 by the dispensing method or the screen-printing method. Further, the moisture absorber 170 can include at least one of barium Ba and calcium Ca. Alternatively, the moisture absorber 170 may include various known materials such as “Drylox” from Dupont or “DESIPASTE” from Süd-Chemie AG.

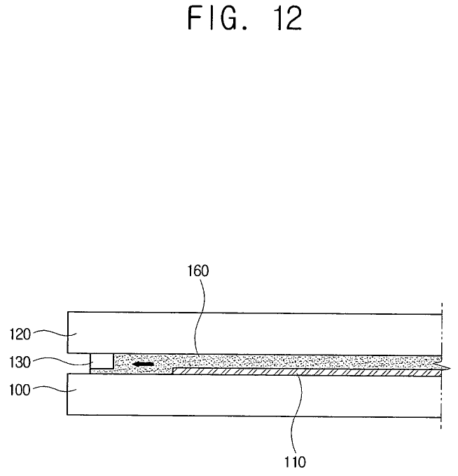

Exemplary flat panel displays according to ninth through eleventh exemplary embodiments of the present invention will be described with reference to FIGS. 12 through 14. The ninth through eleventh exemplary embodiments relate to flat panel displays having sealing structures different from that of the eighth exemplary embodiment. In the ninth through eleventh exemplary embodiments, only different features from the eighth exemplary embodiment will be described, and reference may be made to the eighth exemplary embodiment or a known structure for omitted descriptions. For convenience, like numerals refer to like elements.

FIG. 12 is a perspective view illustrating a structure of an exemplary flat panel display according to a ninth exemplary embodiment of the present invention. Unlike the eighth exemplary embodiment, in the ninth exemplary embodiment, the space 161 and the moisture absorber 170 as shown in FIG. 11 are not provided, and a filler 160 is partially extended in an arrow direction between the frit 130 and the insulating substrate 100. According to the present invention, the frit 130 has good durability and very low permeability to moisture, thereby reliably minimizing the permeability of moisture and oxygen without the moisture absorber 170. As the moisture absorber 170 is not needed in this embodiment, a production cost decreases. Here, the filler 160 provided on the insulating substrate 100 or the cover substrate 120 is filled between the frit 130 and the insulating substrate 100 when the insulating substrate 100 or the cover substrate 120 are pressed, thereby forming the flat panel display as shown in FIG. 12. Thus, there is provided the flat panel display of which the production cost decreases and oxygen and moisture introduced from the outside is minimized.

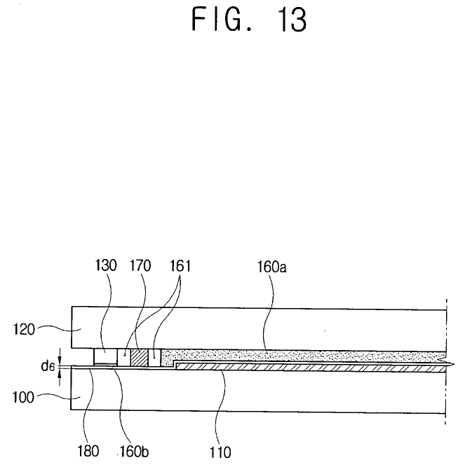

FIG. 13 is a perspective view illustrating a structure of an exemplary flat panel display according to a tenth exemplary embodiment of the present invention. As shown in FIG. 13, a first inorganic film 180 is formed between the display element 110 and the filler 160. The first inorganic film 180 may further extend between the insulating substrate 100 and the frit 130, the moisture absorber 170, and the space 161. The first inorganic film 180 has a thickness d6 of about 100 nm through 3000 nm, and has a single or multi-layered structure. In the case of the multi-layered structure, the respective layers may be made of different materials or formed by different methods. Thus, the first inorganic film 180 including an inorganic material having excellent moisture-proof properties and non-permeability of moisture is provided, thereby protecting the display element 110 from moisture and oxygen.

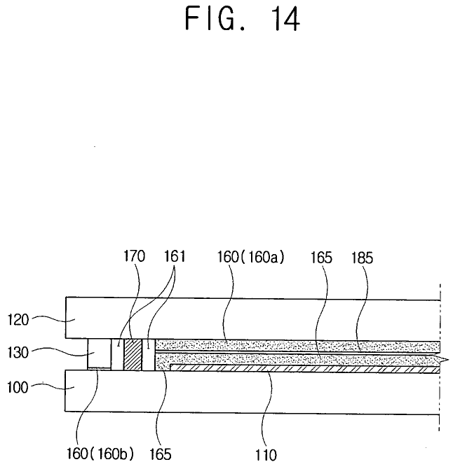

FIG. 14 is a perspective view illustrating a structure of an exemplary flat panel display according to an eleventh exemplary embodiment of the present invention. As shown in FIG. 14, a filler 160 and an additional filler 165 are provided between the insulating substrate 100 and the cover substrate 120, and a second inorganic film 185 is provided between the filler 160 and the additional filler 165. The two substrates 100 and 120 are joined with each other after the filler 160 is provided on the cover substrate 120 and the additional filler 165 and the second inorganic film 185 are provided on the insulating substrate 100. Alternatively, the filler 160, the second inorganic film 185, and the additional filler 165 are formed in sequence on one of the insulating substrate 100 and the cover substrate 120, and that substrate is then joined with the other substrate. Like the first inorganic film 180 shown in FIG. 13, the second inorganic film 185 can have a thickness of about 100 nm through 3000 nm, and have a single or multi-layered structure. In addition, although not illustrated, the first inorganic film 180 may also be provided to cover the display element 110 within the eleventh exemplary embodiment, as in the tenth exemplary embodiment. Thus, there is provided a flat panel display in which moisture and oxygen from the outside are effectively blocked off.

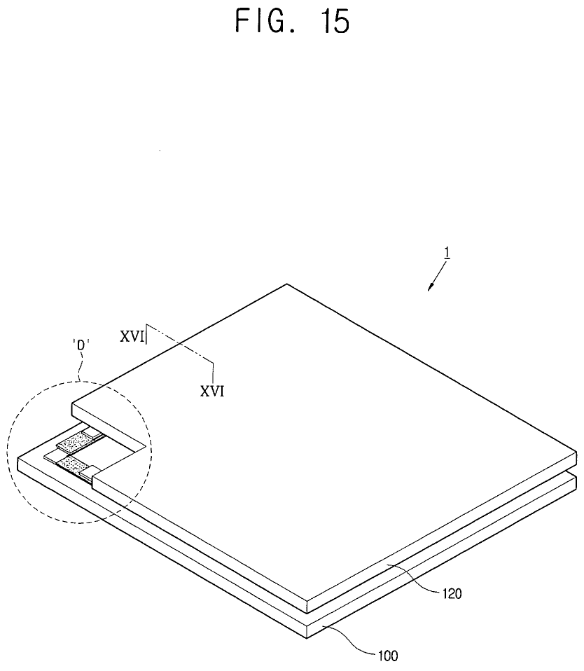

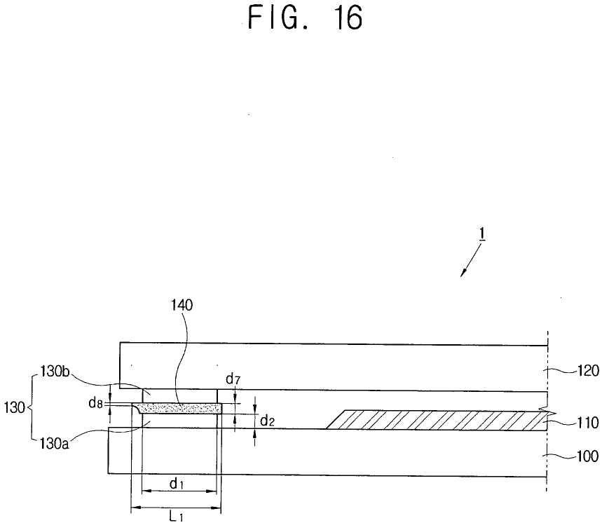

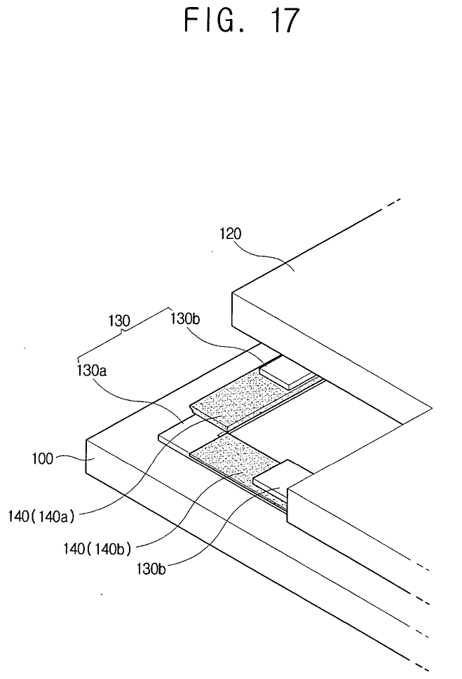

An exemplary flat panel display according to a twelfth exemplary embodiment of the present invention will be described with reference to FIGS. 15 through 18B. The twelfth exemplary embodiment relates to a sealing structure of the OLED, which is different from that of the first exemplary embodiment, and more particularly, to a sealing structure using a frit for sealing the OLED. In the twelfth exemplary embodiment, only different features from the first exemplary embodiment will be described, and reference should be made to the first exemplary embodiment or a publicly known structure for omitted descriptions. For convenience, like numerals refer to like elements.

As shown in FIGS. 15 through 17, the frit 130 according to the twelfth exemplary embodiment of the present invention includes a first frit 130a contacting the insulating substrate 100, and a second frit 130b contacting the cover substrate 120. The first and second frits 130a and 130b can be formed by one of a screen-printing method, a dispensing method, and a dipping method. Each of the first and second frits 130a and 130b has a width d1 of 0.1 mm through 5 mm, and a thickness d2 of 5 μm through 3 mm. The ranges for width and thickness allow for the two substrates 100 and 120 to be stably joined together and provide the advantages to the OLED 1.

As shown in FIGS. 15 through 18B, the heat transfer member 140 is inserted in the frit 130.

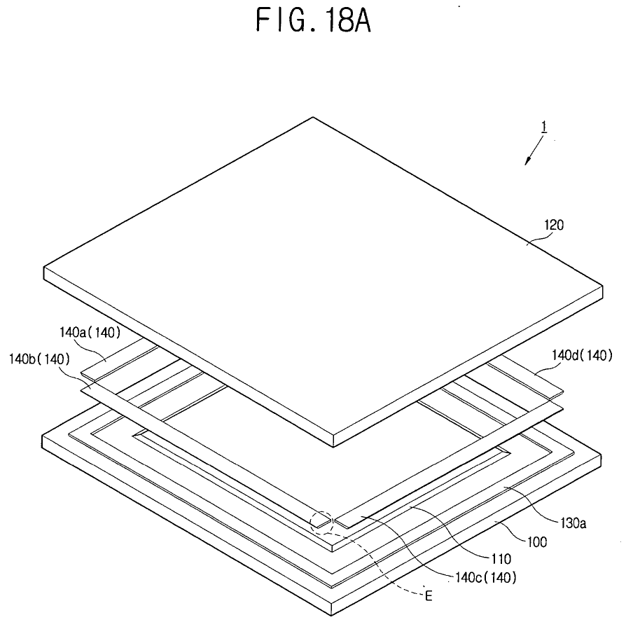

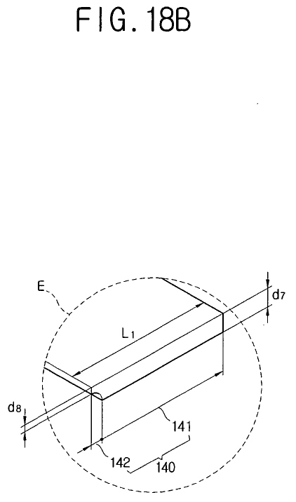

Referring to FIGS. 18A and 18B, the heat transfer member 140 substantially has a rectangular shape, and includes a first sub-plate 140a, a second sub-plate 140b, a third sub-plate 140c, and a fourth sub-plate 140d. Each of the sub-plates 140a, 140b, 140c, and 140d includes a main body 141 inserted in the frit 130 between the first and second frits 130a, 130b, and a cut part 142 extended from the main body 141 away from the frit 130 and decreased in thickness. That is, the thickness d8 at the end of the cut part 142 is thinner than the thickness d7 of the main body 141. Further, the cut part 142 is lengthwise along each long edge of the first through fourth sub-plates 140a, 140b, 140c, and 140d. The purpose of the foregoing structure of the heat transfer member 140 will be described below with the description of a fabricating process of the flat panel display according to the twelfth exemplary embodiment.

The main body 141 has a thickness d7 of 10 μm through 1000 μm, and the thickness d8 at the end of the cut part 142 is 30% through 80% of the thickness d7. If the thickness d7 of the main body 141 is smaller than 10 μm, then it would be unsuitable to radiate heat for curing the frit 130. In order to cure the frit 130, a temperature of 300° C. or more is required. Thus, if the thickness d7 of the main body 141 is smaller than 10 μm, then the heat transfer member 140 may be short-circuited when high voltage is applied thereto and be unsuitable for radiating heat at a temperature of 300° C. or more. Further, if the thickness d7 of the main body 141 is smaller than 10 μm, the frit 130 is not entirely cured, thereby causing defective adhesion. On the other hand, if the thickness d7 of the main body 141 is larger than 1000 μm, then it would not properly make the display compact. Also, if the thickness d7 of the main body 141 is larger than 1000 μm, then heat at an excessively high temperature of 700° C. or more may be applied to the main body 141, and the interior metal wiring lines of the display element 110 may be affected by the heat, thereby causing defects. Meanwhile, the gate or data lines of the interior metal wiring lines may include aluminum, and the high-temperature heat can change the resistance of the gate or data lines because the melting point of aluminum is relatively low. Thus, a video signal may be abnormally transmitted, and so an undesired image may be displayed. The lengthwise edge of the heat transfer member 140 is provided to have substantially the same length as the edge of the insulating substrate 100. In other words, the lengthwise edge of the heat transfer member 140 may be approximately equal to, larger than, or smaller than the edge of the insulating substrate 100. Further, the short edge L1 of the heat transfer member 140 is larger than the width d1 of the frit 130.

Thus, it is preferable for curing the frit 130 that the thickness d7 and the length L1 of the main body 141 are formed in proportion to the width d1 and the thickness d2 of the frit 130.

The heat transfer member 140 includes at least one material selected from a group consisting of stainless steel, iron, molybdenum, nickel, titanium, tungsten, aluminum, and alloy thereof. However, the heat transfer member 140 is not limited to the foregoing materials. Alternatively, the heat transfer member may include other materials than the foregoing materials as long as it is conductive to supply the high-temperature heat to the frit 130. Further, a passivation layer may be provided to prevent the heat transfer member 140 from oxidation. The passivation layer can be implemented by an inorganic layer including at least one of an oxide layer, a nitride layer, and a pyro-carbon layer.

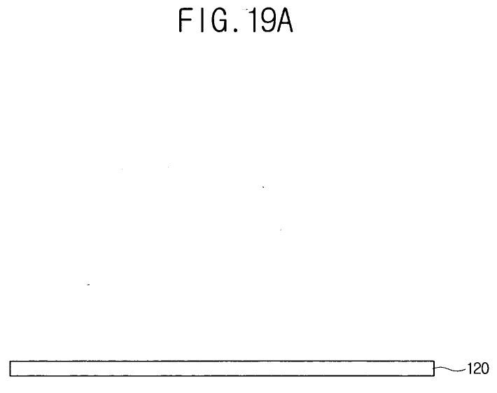

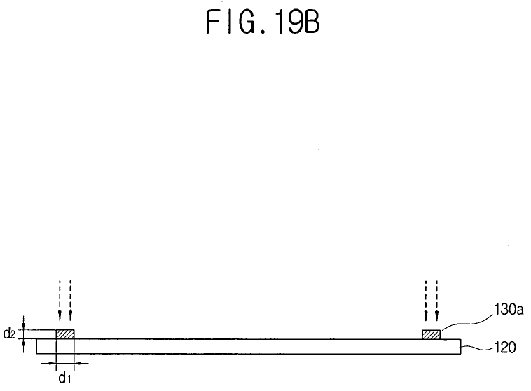

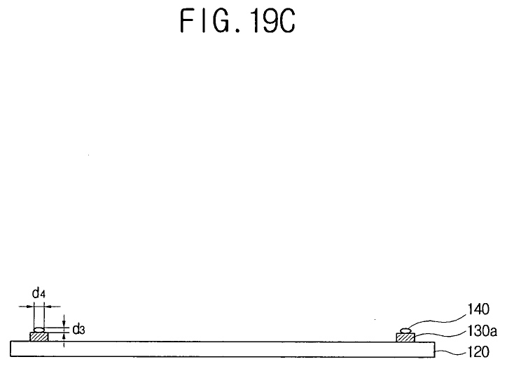

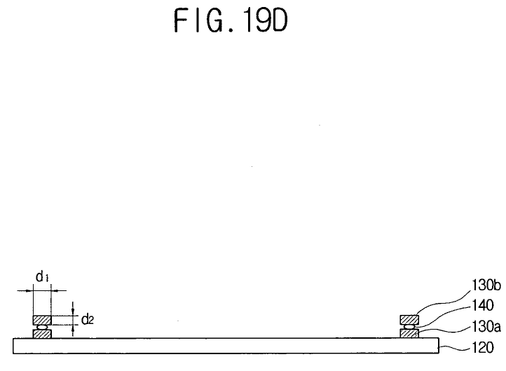

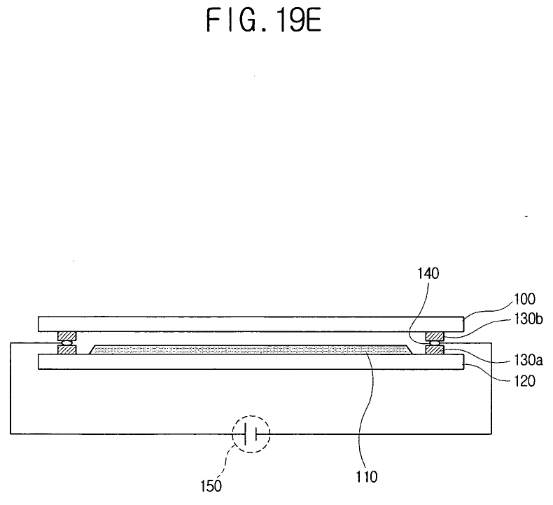

A method of fabricating the exemplary flat panel display according to exemplary embodiments of the present invention will be described with reference to FIGS. 19A through 19E. FIGS. 19A through 19E are sectional views showing the exemplary fabricating method according to the first exemplary embodiment of the present invention.

First, as shown in FIG. 19A, the cover substrate 120 is provided. The cover substrate 120 is made of a glass or plastic substrate as is the insulating substrate 100. Alternatively, the cover substrate 120 may be made of a soda-lime glass substrate, a boro-silicate glass substrate, a silicate glass substrate, and a lead glass substrate, etc. The cover substrate 120 can have a thickness of 0.1 mm through 10 mm, and more preferably 1 mm through 10 mm, for a sufficient thickness to prevent moisture or oxygen from being permeated into the display element 110 through the cover substrate 120. Further, a barrier layer (not shown) may be formed on the cover substrate 120 by the sputtering method, which includes SiON, SiO₂, SiNₓ, Al₂O₃, etc. Here, the barrier layer prevents oxygen or moisture from being introduced from the outside.

Referring to FIG. 19B, a first frit 130a is formed along an edge of the cover substrate 120. The first frit 130a can be formed by a dispensing method or a screen-printing method. Such a frit 130a includes an adhesive powdered glass such as SiO₂, TiO₂, PbO, PbTiO₃, Al₂O₃, etc. Further, the frit 130a has a very low permeability to moisture and oxygen, so that the organic emission layer within a display element is prevented from deteriorating and a water getter is not needed. Also, the first frit 130a has a sufficient durability to endure vacuum mounting, so that the OLED can be fabricated in a vacuum chamber, thereby minimizing the permeability of oxygen and moisture from the outside. The first frit 130a has a width d1 of 0.1 mm through 5 mm, and a thickness d2 of 5 μm through 3 mm. Such ranges are provided for allowing the two substrates 100 and 120 to be stably joined together and have the advantages previously described.

Then, the first frit 130a is semi-cured, so that impurities contained in the first frit 130a and bubbles to be generated when cured are removed. The semi-curing process is performed at a temperature of 100° C. through 250° C. Further, an oven and a hot-plate can be used in the semi-curing process. Alternatively, a laser may be used in the semi-curing process. This process is optional, but good to improve the performance and the lifespan of a product. After the semi-curing process, a process of planarizing the first frit 130a can be additionally performed to remove the bubbles generated in the first frit 130a and enhance adhesion to the insulating substrate 100 having the display element 110.

Referring to FIG. 19C, the heat transfer member 140 is formed along the first frit 130a. The heat transfer member 140 is a wiring line such as a hot wire, and can be shaped like a line, a zigzag, a mesh, a sheet, a thin film, etc. In FIG. 19C, the heat transfer member 140 is exemplarily formed as the wiring line or the sheet shape. In this case, the heat transfer member 140 has a thickness d3 of 50 μm through 5 mm, and a width d4 of 5 μm through 5 mm. Such ranges are provided for increasing the temperature of the frit 130a, 130b to be cured from the electrical resistance point of view and minimizing the defective adhesion. Further, the ranges are provided for making the flat panel display thin and minimizing defects in the under metal wiring line.

Here, the heat transfer member 140 includes at least one of nickel, tungsten, Kanthal and alloy thereof, and is formed by the sputtering method or the CVD method. Further, the heat transfer member 140 may be conductive. As shown in FIG. 1, both ends of the heat transfer member 140 are connected to the power supply 150. When the power supply 150 supplies power to the heat transfer member 140, the heat transfer member 140 generates heat and cures the frit 130. In addition, the heat transfer member 140 may be covered with a passivation layer (not shown) to prevent the heat transfer member 140 from being oxidized. Here, the passivation layer may be an inorganic material including at least one of an oxide layer, a nitride layer, and pyro-carbon.

In the meantime, when it is difficult to use the oven, the hot-plate, and the laser, or when the first frit 130a is semi-cured without a separate device, the heat transfer member 140 provided on the first frit 130a can be used to semi-cure the first frit 130a. In this case, the heat transfer member 140 is formed along the first frit 130a after forming the first frit 130a, and is then connected to the power supply 150 as shown in FIG. 1, so that it is possible to semi-cure the frit 130a.

Referring to FIG. 19D, a second frit 130b is formed on the heat transfer member 140. The second frit 130b can be formed by the same method and under the same conditions as the first frit 130a.

Referring to FIG. 19E, the insulating substrate 100 provided with the display element 110 is joined to the cover substrate 120, and then power is supplied to the heat transfer member 140 via the power supply 150 while pressing the two substrates 100 and 120, thereby curing the frits 130a and 130b. Preferably, the curing process is performed at a temperature of 400° C. or more to completely cure the frits 130a and 130b. Further, the heat transfer member 140 can be connected to the power supply 150 before or after joining the two substrates 100 and 120 together. Preferably, the process of joining the two substrates 100 and 120 is performed in the vacuum chamber and with a pressure of about 760 torr. Further, the power supply 150 can be a general well-known device. The power supply 150 can be an RF power source supplying high frequency power. The power supply 150 is not included in the OLED 1, so that it can be removed after supplying power to the heat transfer member 140 for curing the frits 130a and 130b. Thus, the display element 110 is effectively protected from moisture and oxygen. Such an encapsulating process is simple, and thus can be easily applied to mass-production.

An exemplary method of fabricating an exemplary flat panel display according to another exemplary embodiment of the present invention will now be described. Here, repetitive descriptions will be avoided as compared with the method based on FIGS. 19A through 19E.

In the OLED 1 according to another exemplary embodiment contrary to FIG. 19D, the second frit 130b is formed on the insulating substrate 100 provided with the display element 110 while facing the first frit 130a of the cover substrate 120, and then the two substrates 100 and 120 are joined together.

According to another exemplary embodiment, there are provided the cover substrate 120 and the insulating substrate 100 having the display element 110. In this embodiment, the heat transfer member 140 is formed along an edge of at least one of the two substrates 100 and 120, and then the frits 130a, 130b are formed in at least one of two substrates 100 and 120 in correspondence with the heat transfer member 140. Then, the two substrates 100 and 120 are joined together and cured.

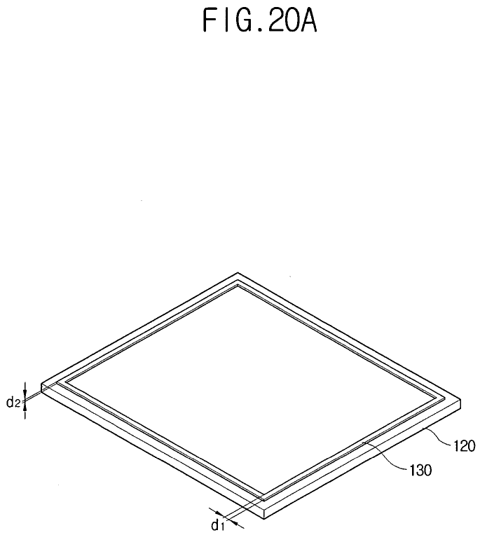

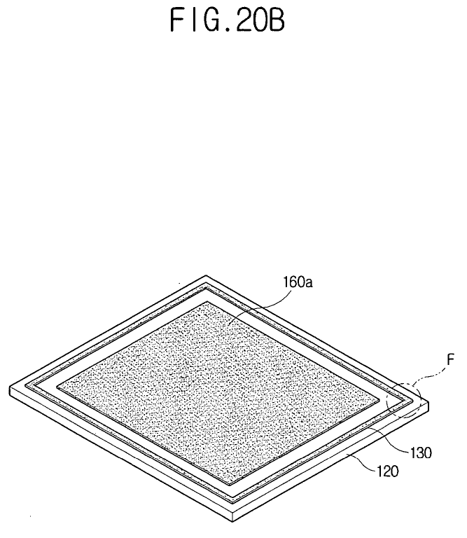

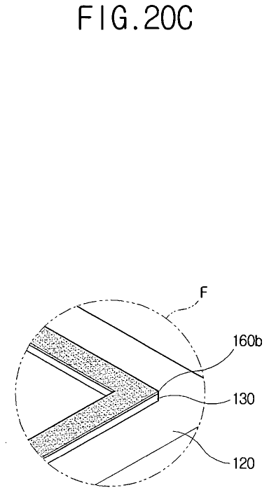

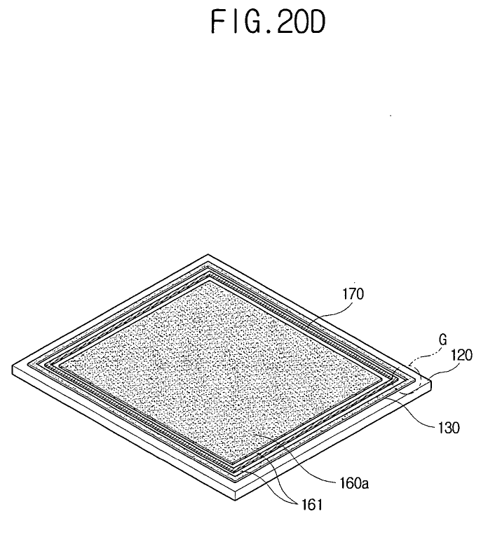

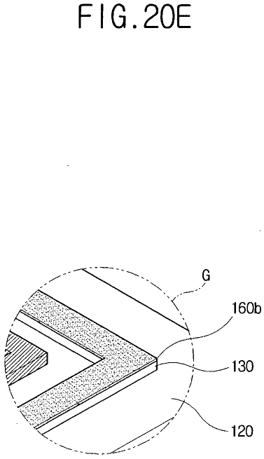

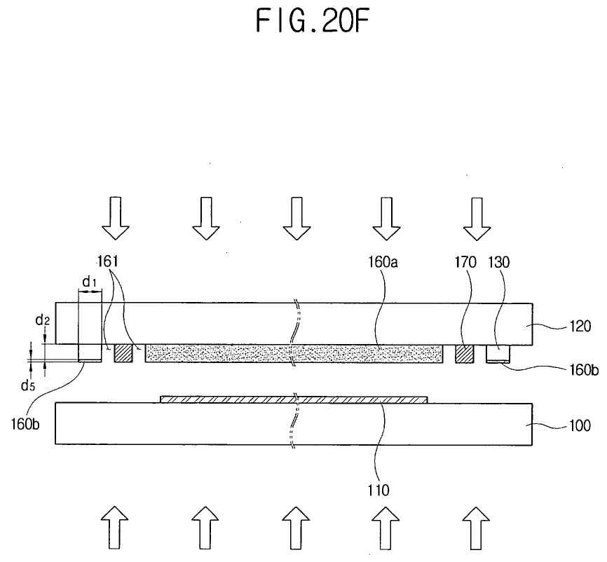

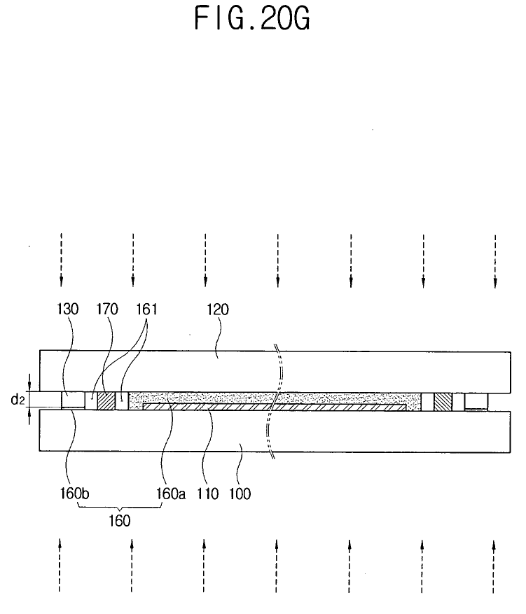

An exemplary method of fabricating the exemplary flat panel display according to the eighth exemplary embodiment of the present invention will be described with reference to FIGS. 20A through 20G.

Referring to FIG. 20A, the frit 130 is formed along the edges of the cover substrate 120. Here, the frit 130 can have a width d1 of 0.1 mm through 5 mm, and a thickness d2 of 5 μm through 3 mm, in which the importance of such ranges are described above. Likewise, the material and the role of the frit 130 are the same as described above. After the frit 130 is formed, the frit 130 is cured by applying a high temperature, such as to the cover substrate 120. To cure the frit 130, a high temperature of about 300° C. or more is required. Further, exemplary methods of curing the frit 130 include applying laser to the frit 130, using an oven, or supplying electric power to a hot wire provided inside the frit 130.

In the conventional method, the frit is cured after forming it on the insulating substrate or in the state that the insulating substrate and the cover substrate are joined together. However, the display element provided on the insulating substrate may become defective because of the high temperature applied for curing the frit. On the other hand, according to the present invention, the frit 130 is cured after forming it on the cover substrate 120, so that a defect of the display element 110 due to the high temperature is minimized or prevented. After the frit 130 is cured, the surface of the frit 130 undergoes the polishing process and is planarized. Thus, the top surface of the frit 130 is improved in flatness and uniformity, thereby enhancing adhesive uniformity and adhesive effect between the two substrates 100 and 120.

Then, as shown in FIGS. 20B and 20C, the filler 160 is formed on the cover substrate 120. Here, the filler 160 can be formed by one of the dispensing method, the screen-printing method, the slit-coating method, and the roll-printing method. According to the eighth exemplary embodiment, the filler 160 includes the first part 160a provided on an area of the cover substrate 120 corresponding to the display element 110, and the second part 160b spaced apart from the first part 160a and formed on the frit 130. The first part 160a protects the display element 110, and the second part 160b joins the frit 130 with the insulating substrate 110. Alternatively, the filler 160 may be formed on the insulating substrate 100.

Then, as shown in FIGS. 20D and 20E, a liquid moisture absorbing solution is dropped within the space 161 between the first part 160a of the filler 160 and the frit 130, thereby forming the moisture absorber 170 on the cover substrate 120. Here, the moisture absorber 170 can be formed by dropping the moisture absorbing solution within the space 161 while a dispenser is moved along the space 161, or by the screen-printing method. The moisture absorber 170 has a very low permeability to moisture and oxygen, so that the organic emission layer within the display element 110 is prevented from deteriorating.

Alternatively, the moisture absorber 170 may be formed on the cover substrate 120 before forming the filler 160. Then, the moisture absorber 170 and the frit 130 can be cured at the same time, or the moisture absorber 170 can be separately cured after curing the frit 130.

Then, as shown in FIG. 20F, the insulating substrate 100 and the cover substrate 120 are aligned and joined with each other. Preferably, the two substrates 100 and 120 are pressed to make the filler 160 cover the display element 110 formed on the insulating substrate 100 uniformly. Further, the two substrates 100 and 120 are pressed to minimize the distance there between, so that oxygen and moisture, which can be introduced between the two substrates 100 and 120, are minimized.

Then, as shown in FIG. 20G, in the state that the two substrates 100 and 120 are joined to each other, at least one of heat and light is applied to the filler 160 and the moisture absorber 170, so that the filler 160 and the moisture absorber 170 are cured, thereby completing the OLED 1.

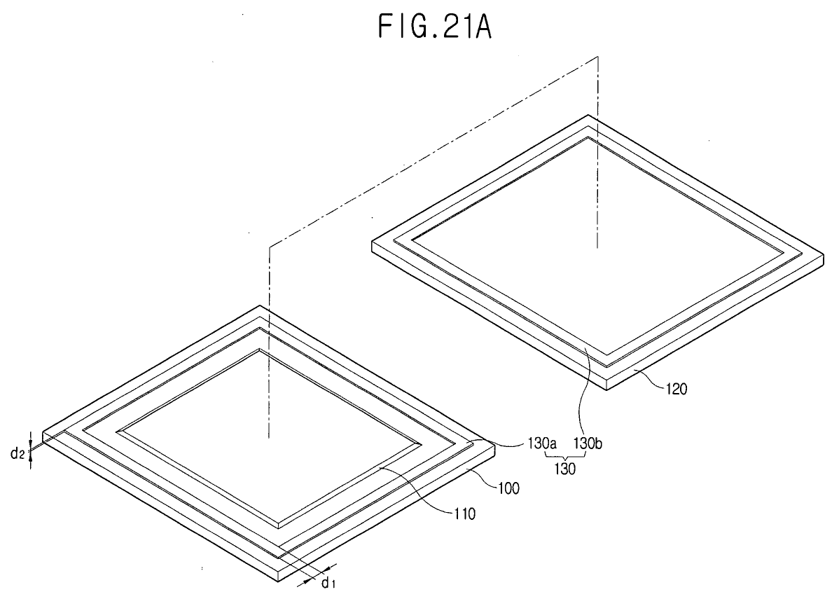

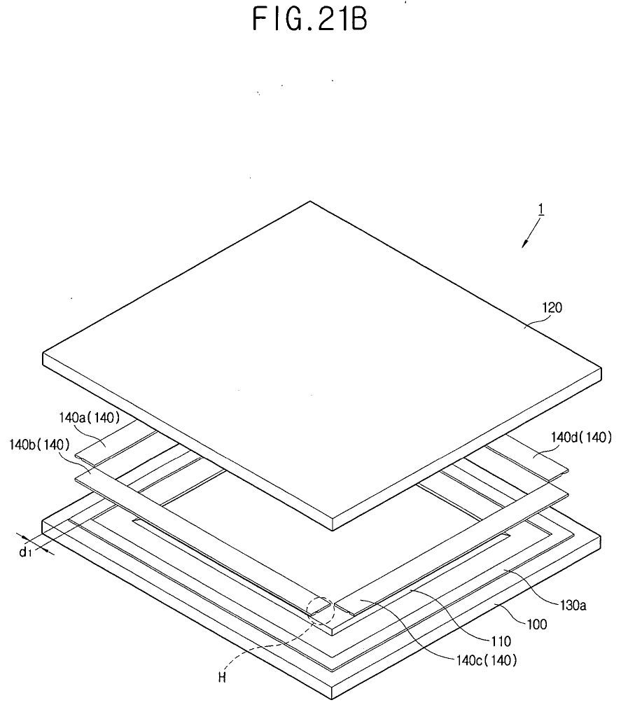

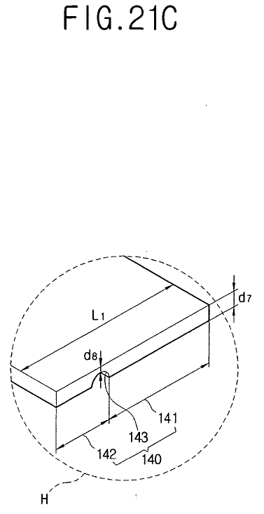

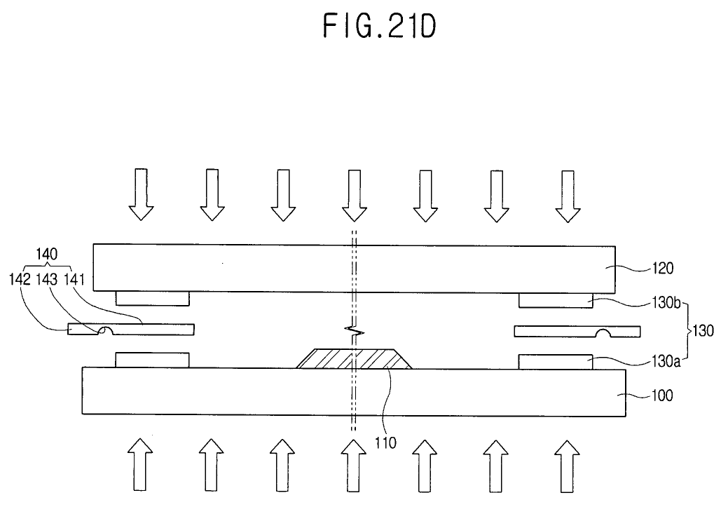

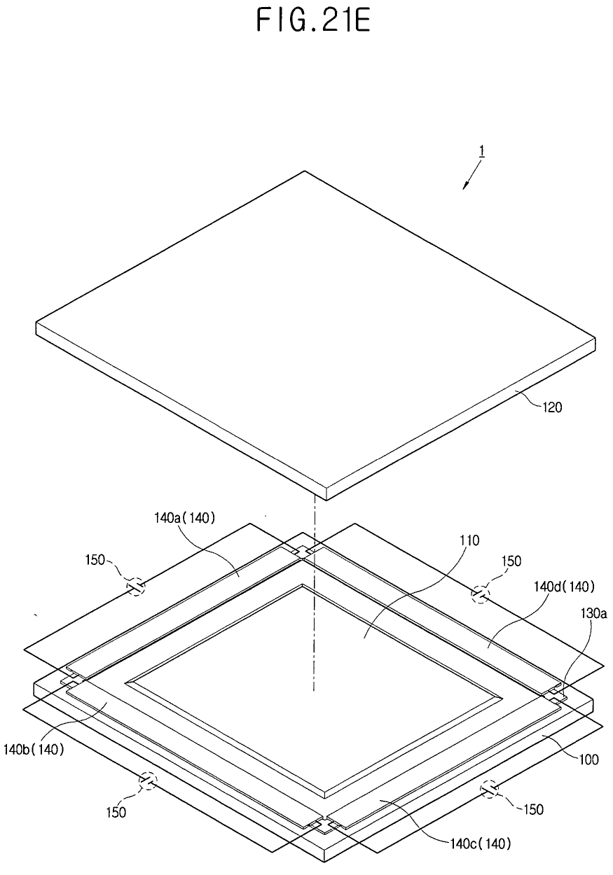

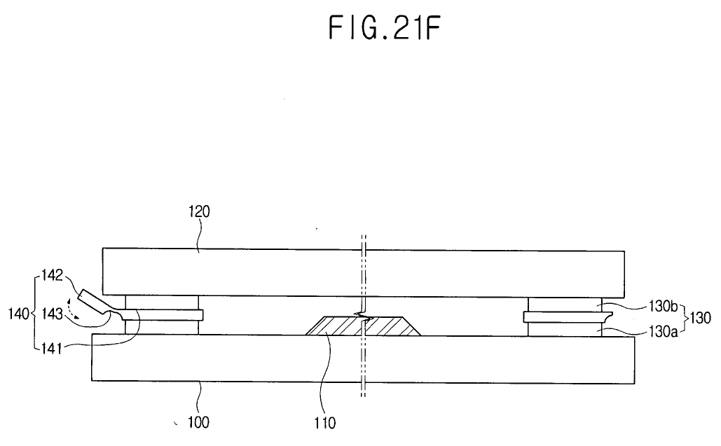

An exemplary method of fabricating the exemplary flat panel display according to the twelfth exemplary embodiment of the present invention will be described with reference to FIGS. 21A through 21F.

First, as shown in FIG. 21A, the frit 130 is formed on the insulating substrate 100 and the cover substrate 120. In more detail, the first frit 130a and the second frit 130b are formed along the edges of the insulating substrate 100 and the cover substrate 120, respectively. The first frit 130a and the second frit 130b can be formed by one of the screen-printing method, the dispensing method, and the dipping method. The processes of forming the first and second frits 130a and 130b can be performed at the same time, or can be performed in sequence.

Such a frit 130 includes an adhesive powdered glass such as SiO₂, TiO₂, PbO, PbTiO₃, Al₂O₃, etc. Further, the frit 130 has a very low permeability to moisture and oxygen, so that the organic emission layer within the display element 110 is prevented from deteriorating and a water getter is not needed. Also, the frit 130 has sufficient durability to endure vacuum mounting, so that the OLED can be fabricated in a vacuum chamber, thereby minimizing the permeability of oxygen and moisture from the outside. The first and second frits 130a and 130b have a width d1 of 0.1 mm through 5 mm, and a thickness d2 of 5 μm through 3 mm. Such ranges allow the two substrates 100 and 120 to be stably joined together and have merits as a product as previously described.

The insulating substrate 100 is already formed with the display element 110 prior to forming the first frit 130a thereon.

As shown in FIGS. 21B and 21C, the insulating substrate 100, the cover substrate 120, and the heat transfer member 140 are aligned such that the heat transfer member 140 manufactured by injecting molding or extrusion molding is partially interposed between the first frit 130a and the second frit 130b opposite to each other. Referring to FIG. 21B, the heat transfer member 140 substantially includes rectangular plates. The heat transfer member 140 includes the first sub-plate 140a, the second sub-plate 140b, the third sub-plate 140c, and the fourth sub-plate 140d. As shown in FIG. 21C, each of the sub-plates 140a, 140b, 140c, and 140d includes the main body 141 to be inserted between the first and second frits 130a and 130b, and a cut part 142 extended outwardly from the main body 141 and formed with a cut groove 143. The heat transfer member 140 is disposed to interpose the main body 141 between the first and second frits 130a and 130b. Further, each sub-plate 140a, 140b, 140c, and 140d is decreased in thickness within the cut groove 143. Each cut groove 143 is provided adjacent each lengthwise edge of the first through fourth sub-plates 140a, 140b, 140c, and 140d. The main body 141 has a thickness d7 of 10 μm through 1000 μm, and the thickness d8 at the cut groove 143 of the cut part 142 is 30% through 80% of the thickness d7. The lengthwise edge of the first through fourth sub-plates 140a, 140b, 140c, and 140d is provided to substantially have the same length as the edge of the insulating substrate 100. Further, the short edge of the heat transfer member 140 has a length L1 longer than the width d1 of the frit 130. Such dimensions are needed for obtaining the proper temperature to cure the frits 130a and 130b and for minimizing defective adhesion. Further, such dimensions are needed for making the display compact and minimizing defects of a lower metal wiring line.

Then, as shown in FIG. 21D, the insulating substrate 100 and the cover substrate 120 are joined together while making the display element 110 face the cover substrate 120. Preferably, this joining process is performed in a vacuum chamber with a pressure of about 760 torr. The main body 141 of the heat transfer member 140 is aligned between the frits 130a and 130b such that the cut part 142 of the heat transfer member 140 is positioned outside of the frit 130.

Then, as shown in FIG. 21E, a power supply 150 is connected between opposite ends of the heat transfer member 140 and supplies electric power to the heat transfer member 140, thereby curing the frit 130. In more detail, when electric power is supplied to the heat transfer member 140, heat is generated owing to the interior resistance of the heat transfer member 140 and thus cures the frit 130. To completely cure the frit 130, the electric power is supplied such that the heat transfer member 140 is heated within the temperature of 300° C. through 700° C. The power supply 150 may be connected to the heat transfer member 140 after the two substrates 100 and 120 are joined together. Alternatively, the power supply 150 may be connected to the heat transfer member 140 before the two substrates 100 and 120 are joined together. Here, the power supply 150 can be implemented by a publicly-known device that is generally capable of supplying electric power. For example, an RF power source supplying high frequency power may be employed for the power supply 150. Since the power supply 150 is not included in the OLED 1, it is removed after supplying power to the heat transfer member 140 for curing the frit 130. Thus, the display element 110 is effectively protected from moisture and oxygen. Such an encapsulating process is simple, and thus can be easily applied to mass-production.

As shown in FIG. 21F, the cut part 142 of the heat transfer member 140 is removed from the main body 141, such as by a cutting process. The cutting process for the cut part 142 is performed by bending the cut part 142 up and down with respect to the cut groove 143. Alternatively, the cut part 142 may be removed from the main body 141 by cutting the cut groove 143 with a cutting tool such as a knife. Thus, the heat transfer member 140 includes the cut groove 143 having the relatively thin thickness, so that the cut part 142, which of no use after curing the frit 130, can be easily removed after the curing process. Therefore, the OLED 1 is completed while the end of the cut part 142 is decreased in thickness as compared with that of the main body 141, as shown in FIG. 18B.

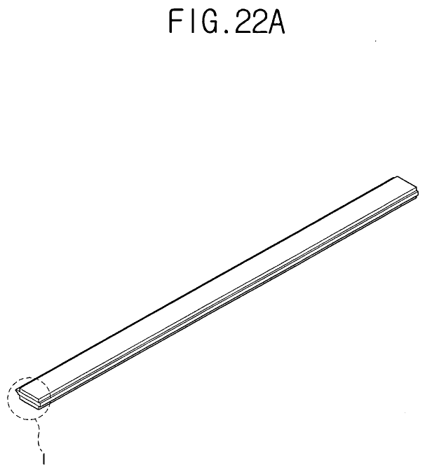

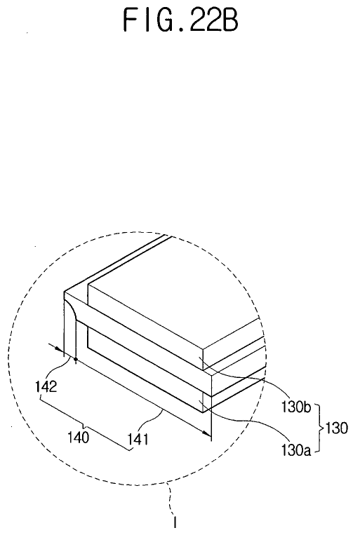

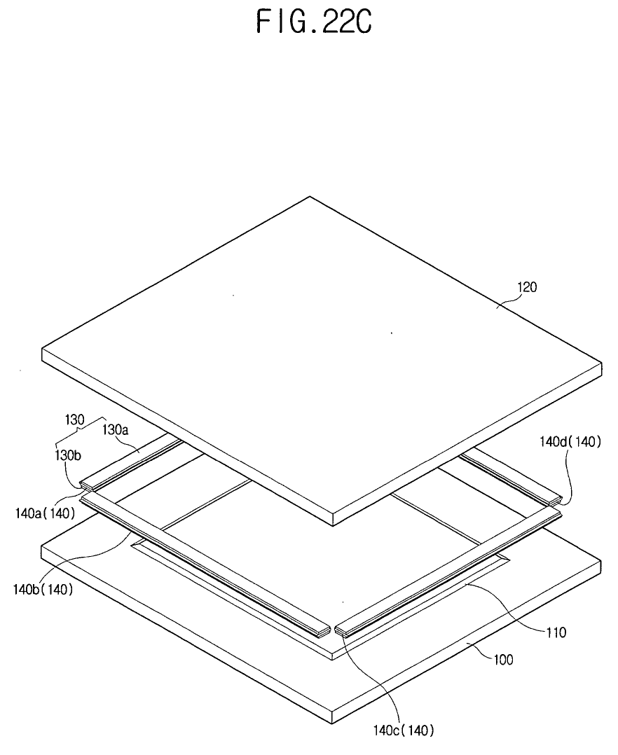

Another exemplary method of fabricating the exemplary flat panel display according to the twelfth exemplary embodiment of the present invention will be described with reference to FIGS. 22A, 22B, and 22C. In the following description, only different features from the foregoing exemplary fabricating method will be described, and thus reference may be made to the foregoing fabricating method or publicly known technology for omitted or brief descriptions. For convenience, like numerals refer to like elements.

First, as shown in FIGS. 22A and 22B, the first frit 130a and the second frit 130b are attached to opposite surfaces of the heat transfer member 140 manufactured by injection molding or extrusion molding. In more detail, the first frit 130a is formed on one surface of the main body 141, and the second frit 130b is formed on an opposite surface of the main body 141. Here, the frit 130 can have a predetermined viscous property, and can be attached to the opposite surfaces of the main body 141 by the dispensing method, the screen-printing method, or the dipping method.

As shown in FIG. 22C, after forming the first and second frits 130a and 130b on opposite surfaces of each of the sub-plates 140a, 140b, 140c, and 140d, the insulating substrate 100, the cover substrate 120, and the heat transfer member 140 are aligned such that the first and second frits 130a and 130b are disposed between the edge of the insulating substrate 100 and the cover substrate 120.

As in the fabricating method of the first exemplary embodiment, the power supply is connected to and supplies electric power to the heat transfer member 140 so as to cure the frit 130. Then, the cut part 142 is removed at the cut groove 143, thereby completing the OLED. As described above, the present invention provides a flat panel display that can minimize inflow of oxygen and moisture from the outside.

Further, the present invention provides a method of fabricating a flat panel display that can minimize inflow of oxygen and moisture from the outside.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A flat panel display comprising:
an insulating substrate having a display element disposed thereon;
a cover substrate facing and joined with the insulating substrate; and
a frit formed along an edge between the insulating substrate and the cover substrate.

2. The flat panel display according to claim 1, further comprising a heat transfer member formed along the frit.

3. The flat panel display according to claim 2, wherein the heat transfer member is inserted in the frit.

4. The flat panel display according to claim 3, wherein the frit has a width within a range of 0.1 mm to 5 mm.

5. The flat panel display according to claim 3, wherein the frit has a thickness within a range of 5 μm to 3 mm.

6. The flat panel display according to claim 3, wherein an end of the heat transfer member is decreased in thickness in a direction extending away from the frit.

7. The flat panel display according to claim 6, wherein the heat transfer member comprises a main body inserted in the frit, and a cut part formed at an end of the main body and thinner than the main body.

8. The flat panel display according to claim 7, wherein the main body has a thickness within a range of 10 μm to 1000 μm.

9. The flat panel display according to claim 8, wherein a thickness of the cut part is within a range of 30% to 80% of the thickness of the main body.

10. The flat panel display according to claim 7, wherein the insulating substrate is substantially shaped like a rectangular plate having four sides, and
the heat transfer member comprises a first sub-plate, a second sub-plate, a third sub-plate, and a fourth sub-plate corresponding to the four sides of the insulating substrate.

11. The flat panel display according to claim 10, wherein each of the first through fourth sub-plates is shaped like an oblong plate having a lengthwise edge and a short edge;
the lengthwise edge of each first through fourth sub-plate is substantially equal to each edge of the insulating substrate, respectively; and
the short edge of each first through fourth sub-plate is larger than a width of the frit.

12. The flat panel display according to claim 11, wherein the cut part is provided along each lengthwise edge of the first through fourth sub-plates.

13. The flat panel display according to claim 6, wherein the heat transfer member includes at least one material selected from a group consisting of stainless steel, iron, molybdenum, nickel, titanium, tungsten, aluminum, and alloy thereof.

14. The flat panel display according to claim 2, wherein the heat transfer member is provided between the frit and at least one of the insulating substrate and the cover substrate.

15. The flat panel display according to claim 2, wherein the heat transfer member is provided in at least one side of the frit.

16. The flat panel display according to claim 2, wherein the heat transfer member comprises at least one wiring line.

17. The flat panel display according to claim 16, wherein the heat transfer member is arranged in a zigzag shape.

18. The flat panel display according to claim 16, wherein the heat transfer member is arranged in a mesh shape.

19. The flat panel display according to claim 16, wherein the heat transfer member has a thickness within a range of 50 μm to 5 mm.

20. The flat panel display according to claim 16, wherein the heat transfer member has a width within a range of 5 μm to 5 mm.

21. The flat panel display according to claim 2, wherein the heat transfer member is sheet-shaped and has a predetermined width.

22. The flat panel display according to claim 21, wherein the heat transfer member has a thin film shape.

23. The flat panel display according to claim 22, wherein the heat transfer member has a thickness within a range of 5 μm to 50 μm.

24. The flat panel display according to claim 22, wherein the heat transfer member has a width of 0.1 mm through 5 mm.

25. The flat panel display according to claim 2, wherein the frit is cured by heat.

26. The flat panel display according to claim 2, wherein the heat transfer member comprises at least one of nickel, tungsten, kanthal and alloy thereof.

27. The flat panel display according to claim 2, wherein the frit and the heat transfer member are alternately stacked to have a multi-layered structure.

28. The flat panel display according to claim 2, wherein the heat transfer member is formed with a passivation layer for anti-oxidization.

29. The flat panel display according to claim 28, wherein the passivation layer comprises an inorganic layer including at least one of an oxide layer, a nitride layer, and pyro-carbon.

30. The flat panel display according to claim 2, wherein the insulating substrate is provided with a signal line, and
at least one of the frit and the heat transfer member is at least partially overlapped with the signal line, and a width of the heat transfer member in an overlapped region is different from that of a non-overlapped region.

31. The flat panel display according to claim 30, wherein the width of the heat transfer member in the overlapped region is narrower than that of the non-overlapped region.

32. The flat panel display according to claim 1, further comprising
a filler interposed between the insulating substrate and the cover substrate and joining the insulating and cover substrates together, the filler comprising a first part spaced apart from the frit and covering the display element, and a second part interposed between the frit and the insulating substrate.

33. The flat panel display according to claim 32, wherein the frit has a thickness within a range of 100 μm to 600 μm.

34. The flat panel display according to claim 33, wherein the frit has a permeability to moisture within a range of 1g/m² day to 10g/m² day.

35. The flat panel display according to claim 32, further comprising a moisture absorber provided in a space between the frit and the first part of the filler.

36. The flat panel display according to claim 35, wherein the moisture absorber is spaced apart from at least one of the frit and the first part at a predetermined distance, and comprises at least one of calcium and barium.

37. The flat panel display according to claim 32, further comprising a first inorganic film interposed between the display element and the filler.

38. The flat panel display according to claim 37, wherein the first part of the filler is a first filler, and further comprising a second inorganic film and an additional filler, which are interposed between the first filler and the insulating substrate,
wherein the second inorganic film is placed on the first filler, and the additional filler is placed between the second inorganic film and the cover substrate.

39. The flat panel display according to claim 38, wherein the first and second inorganic films have a thickness within a range of 100 nm to 3000 nm, and have a multi-layered structure.

40. The flat panel display according to claim 32, wherein a surface of the frit facing the insulating substrate is planarized.

41. A method of fabricating a flat panel display, the method comprising:
preparing a cover substrate;
forming a first frit along an edge of the cover substrate;
forming a heat transfer member along the first frit;
forming a second frit on the heat transfer member; and
aligning an insulating substrate with the cover substrate, the insulating substrate having a display element, and curing the first and second frits by supplying power to the heat transfer member.

42. The method according to claim 41, further comprising semi-curing the first frit before forming the heat transfer member.

43. The method according to claim 42, wherein semi-curing the first frit is performed at a temperature within a range of 100° C. to 250° C.

44. The method according to claim 42, wherein semi-curing the first frit uses at least one of an oven, a hot-plate, and a laser.

45. The method according to claim 41, further comprising semi-curing the first frit after forming the heat transfer member,
wherein semi-curing the first frit is performed by supplying power to the heat transfer member.

46. The method according to claim 45, further comprising planarizing the first frit between semi-curing the first frit and aligning the insulating substrate with the cover substrate.

47. The method according to claim 41, wherein forming the first and second frits includes using a dispensing method or a screen-printing method.

48. The method according to claim 41, wherein curing the first and second frits is performed at a temperature of 300° C. or more.

49. The method according to claim 41, wherein forming the heat transfer member includes using at least one of a sputtering method and a chemical vapor deposition.

50. The method according to claim 41, wherein aligning the insulating substrate with the cover substrate and curing the first and second frits are performed in a vacuum chamber.

51. The method according to claim 41, wherein curing the first and second frits includes providing the heat transfer member with high frequency power from an RF power source.

52. The method according to claim 41, further comprising forming a passivation layer for anti-oxidization on the heat transfer member.

53. A method of fabricating a flat panel display, the method comprising:
preparing a cover substrate;
forming a frit along an edge of the cover substrate;
curing the frit;
forming a filler on at least one of the cover substrate and an insulating substrate formed with a display element; and
curing the filler after joining the cover substrate and the insulating substrate to each other.

54. The method according to claim 53, further comprising planarizing one surface of the frit facing the insulating substrate after curing the frit.

55. The method according to claim 54, wherein the filler comprises a first part corresponding to the display element on either of the insulating substrate or the cover substrate, and a second part formed on the one surface of the frit.

56. The method according to claim 55, further comprising interposing a moisture absorber within a space between the frit and the first part of the filler either before or after forming the filler.

57. The method according to claim 54, further comprising forming an inorganic film covering at least a part of the display element either before or after forming the filler.

58. A method of fabricating a flat panel display, the method comprising:
forming a first frit along an edge of an insulating substrate;
forming a second frit along an edge of a cover substrate;
arranging a heat transfer member having a cut groove partially between the first frit and the second frit;
joining the insulating substrate with the cover substrate;
curing the first and second frits by supplying electric power to the heat transfer member; and
cutting the cut groove.

59. The method according to claim 58, wherein the heat transfer member comprises a main body, and a cut part extended outwardly from the main body and formed with the cut groove, and
joining the insulating substrate with the cover substrate is performed in a state that the heat transfer member is disposed with the main body interposed between the first frit and the second frit.

60. The method according to claim 58, wherein curing the first and second frits comprises supplying the electric power to heat the heat transfer member within a temperature range of 300° C. to 700° C.

61. The method according to claim 58, wherein the heat transfer member has a rectangular plate shape.
